(19) United States
(12) Patent Application Publication
(10) Pub. No.: US 2016/0002842 A1
(43) Pub. Date: Jan. 7, 2016

(54) FLOOD PREVENTION SYSTEMS FOR APPLIANCES

(71) Applicant: Kevin Dawes, West Covina, CA (US)

(72) Inventors: Kevin Dawes, West Covina, CA (US); Jeremiah Friend, Wooster, OH (US); John Cichello, Wooster, OH (US)

(21) Appl. No.: 14/770,783

(22) PCT Filed: Feb. 25, 2014
(86) PCT No.: PCT/US14/18122

§ 371 Date: Aug. 26, 2015

Related U.S. Application Data
(60) Provisional application No. 61/769,692, filed on Feb. 26, 2013.

(51) Int. Cl. D06F 39/08; G05D 7/06

(52) U.S. Cl. CPC D06F 39/087; G05D 7/0617; D06F 39/081; D06F 2202/085; D06F 2204/088

(57) ABSTRACT

A system for preventing and/or controlling flooding caused by blockages in the drain line and/or caused by damage to a water supply line or a water drain line of an appliance such as a washing machine, dishwasher and the like, including (i) a motorized cold water supply line valve, (ii) a motorized hot water supply line valve; (iii) a sealed connection adapted for connection to the appliance discharge line, connection to an atmospheric vent, connection to a float switch and connection to a sewer line; (iv) a including a liquid sensor adapted to generate a fault signal upon detecting liquid on a surface near the washing machine and to transmit the leakage signal to a control processor; and (v) the control processor operable to shut off power to the washing machine upon receipt of the fault signal, and to close the water supply line valves upon loss of power to the washing machine.

### CROSS REFERENCE TO RELATED APPLICATIONS

The present application is a continuation-in-part of and claims the benefit of priority of U.S. application Ser. No. 13/405,261 filed Feb. 25, 2012; claims the benefit of priority of U.S. provisional patent application 61/769,692, filed Feb. 26, 2013; claims the benefit of priority of U.S. provisional application 61/449,691, filed Mar. 6, 2011, by and though application Ser. No. 13/405,261; and incorporates by reference all three of the above-identified applications.

### TECHNICAL FIELD

The present systems and methods relate generally to systems and methods to prevent and/or minimize flooding in, from and near devices and appliances that use a liquid during operation. More specifically, the present systems and methods are directed to preventing and/or minimizing washing machine flooding that commonly occurs due to flaws in conventional systems and methods of connecting a washing machine drain hose to a sewer line drain, methods of installing such systems, damage to or wear and tear on hoses used with washing machines, and other sources of water leakage or flooding associated with use of washing machines. The systems include mechanical devices that function to create a sealed connection between the washing machine drain hose and sewer line drain, sensors that detect water leakage and integrated circuits that control normal operation of the washing machine, provide for damage control once leakage is detected and provide indications for various system parameters. The sensors are capable of detecting blockage in the sewer line drain, detecting water leakage from the washing machine and its water supply and discharge lines. The flood prevention system also includes sub-systems and sub-circuits that function to shut-off the washing machine and cease the pumping of waste water to prevent flooding in the event that blockage in the sewer line drain or water leakage from the washing machine, from its water supply line(s) or from its water discharge line(s) is detected. A preferred embodiment of the present system is provided in a kit that includes not only the housing and its internal plumbing and control system, its external sensors, but also a set of preferred Floodchek™ brand washing machine hoses.

### BACKGROUND ART

The present method of connecting a washing machine drain hose to a sewer line drain is flawed and results in a tremendous amount of property damage, globally every year, due to flooding. Water damage resulting from washing machine flooding is believed to be a costly form of recurring property damage. Specifically, the conventional connection of a washing machine drain hose to a sewer line drain is flawed because the connection is not sealed and is therefore susceptible to flooding. In the conventional system and method of connecting, the washing machine pumps and discharges waste water through a smaller flexible drain hose that is loosely inserted into a larger open sewer line drain. This conventional connection is not sealed in order to provide an “air-gap”, or “vacuum break”, that is needed to prevent self-siphonage during the wash cycle. Without an “air-gap”, or “vacuum break”, the resulting self-siphonage would prematurely empty the washing machine, obviously defeating the function of the washing machine. The present system provides for a solution by incorporating both a sealed connection between the washing machine drain hose and the sewer line drain and a “vacuum break” that prevents self-siphonage. Prior to the present system no system or method that provides both a sealed connection and a “vacuum break” has been available.

One major problem with the current method of connecting a washing machine drain hose to a sewer line drain is that the smaller flexible drain hose, which pumps water out of the washing machine, will sometimes drop-out of the larger open sewer line drain pipe. If the smaller drain hose drops-out of the larger open sewer line drain and is not noticed and rectified immediately, the washing machine will continue through its wash, rinse, and drain cycle thereby pumping a significant amount waste water onto the floor, causing severe flood damage.

The current method is also inherently flawed because it incorporates an open sewer line drain with direct exposure to the living area. Even if the washing machine drain hose does not drop-out of the larger open sewer line drain, the living area remains susceptible to severe flood damage in the event that the sewer line is blocked. An additional problem with the open sewer line drain incorporated in the current method is that it is possible for the water seal in the drain trap to evaporate, thus allowing direct access of foul sewer gases and vermin into the living area. If a blockage occurs in the in-ground or the under floor 2″ or 3″ drain pipe, or in the inline sewer drain, then, as the washing machine washes and drains, the pumped waste water can only escape through the open end of the larger sewer line drain pipe or “vacuum break”. This situation will result in major flooding possibly mixed with foul water. The present system includes sensors to detect blockage and a sub-system to shut-off the washing machine and cease the pumping of waste water to prevent and/or minimize flooding in the event that blockage in the sewer line drain is detected.

### DISCLOSURE OF INVENTION

The present system overcomes the drawbacks of conventional washing machine installations by preventing severe water damage from flooding as well as preventing foul sewer gases and vermin intrusion through the large open sewer line drain through a sealed connection between the washing machine drain hose and the sewer line drain. The presently described no flood washing machine outlet box (NFWMOB) system is a plumbing device intended to prevent leak and flood damage caused by a domestic clothes washer and the ancillary equipment it uses.

The present system incorporates a sealed connection without causing self-siphonage because a sealed vent extends from the sewer line drain above the washing machine drain input connection. The functionality resulting from the structures of the present system that connect a sewer vent pipe above a sealed drain connection is a breakthrough in plumbing technology because it solves the problems caused by induced siphonage and thereby enables the sealed connection without disrupting the functionality of the washing machine.

The present system also includes sensors to detect blockage and an electro-mechanical sub-system that functions to shut-off the washing machine and stop pumping of waste water to thereby prevent flooding in the event of blockage in the sewer line drain.

As a precaution to protect against potential flooding that could result from blockage of the sewer line and a backup of water from a source other than the washing machine, the system optionally could incorporate a conventional one-way check valve or a conventional “duckbill” check valve.

The present system and method provide structures for preventing flooding due to blockage in the drain line of appliances such as washing machines, dishwashers and the like, and methods of installation of such systems. The system may also be provided in a kit form for easy and efficient installation in new construction or in remodeling applications.

In one embodiment and in a simplified form, the system includes a solid connection of an appliance drain line to a horizontally oriented inlet to a T-connection of a pipe, with the main leg or bar of the T lying substantially horizontal to the earth's surface at a first height, and the cross bar pipe of the T oriented vertically. Preferably a flow control device is positioned in the system at some point between the outlet of the appliance and the vertical cross bar pipe. Most preferably the flow control device is a one-way check valve positioned at or near the connection of the appliance drain pipe and the T-connection, and oriented to permit flow of water from the appliance, e.g., the washing machine to the T-connection and to prevent backflow of water from the T-connection to the washing machine.

One leg of the cross bar pipe extends vertically upward from the connection above the first height and is connected to a vent that in turn is in fluid communication to atmosphere to provide a venting function for the system. The other or second leg of the cross bar pipe extends downward from the connection below the first height and is connected to a sewer and a lower, second height.

Positioned at a height intermediate the first and second heights is a flow blockage sensing, alarm and control sub-system that functions to sense when a blockage occurs in the drain system, to provide audible and/or visual alarms when such a blockage is detected and/or to control the appliance by cutting off power to the appliance. By cutting off power to the appliance as soon as a blockage is detected, flooding can be prevented or minimized. This sub-system preferably includes a flow loop in fluid communication with the lower leg of the T-connection, a conventional float actuated switch positioned in the loop, conventional audible and/or visual alarms or indicators operatively connected to the switch, and a circuit operative to cut off power to the washing machine, or other appliance, when a blockage is detected. During operation of a washing machine drain cycle and the present system, and in the event of a blockage in the drain line downstream of the T-connection, draining water will begin to rise in the drain. The water will continue to rise to some height above the second, sewer connection height, and at some point will reach the lower leg of the flow loop, positioned at a third height that is intermediate the first and second heights. The water will then continue to rise and at some point will cause the float of the float actuated switch to rise. The float is positioned in the loop and it will rise with the rising water until it contacts the switch and the float activated switch then causes the alarm(s) to activate and the power to the washing machine to be cut off, thereby stopping the flow of water from the washing machine. The one-way flow check valve operates to prevent any water from back flowing into the washing machine in the event the water level rises to the first height or above.

In another preferred embodiment a connector between the washing machine discharge hose and the T-connection is provided. Preferably, this connector includes a first end with a connection adapted to connect to and provide a tight, closed connection to the T-connection, a second end with a connection adapted to connect to the distal end of a washing machine discharge or drain line, and positioned intermediate the two ends a plurality of connected, telescoping pipe sections of differing diameters that are adapted for connection with washing machine discharge lines of different diameters. In this embodiment a plurality of washing machine discharge or drain line liners are provided to accommodate drain lines of a various diameters.

In another preferred embodiment the above-described system is provided in a kit form, ready to be installed in a new construction or remodel context. In a kit form the T-connection and flow blockage control sub-system are provided in housing or washing machine box that is adapted for easy installation in the building's framework, most preferably in a studded wall. Variations of the kits include, in addition, hot and cold water service connections and valves, alarm indicators, control switches, and inlet and outlet orifices and/or connections for the connection to the washing machine drain line, vent line and sewer drain line. The housing or box may also be provided with brackets, straps, extensions or other members adapted for easy positioning and attachment to the building's frame or wall. In the kit embodiments, the universal washing machine drain connection may be included, or provided separately.

In other preferred, alternate embodiments the internal piping is made of clear plastic so as to enable the status of the drain system to be ascertained by visual inspection; the outlet box is made with doors that permit easy access to the inside of the drain system; a horizontally oriented, conventional float switch is employed rather than a vertically oriented float switch and C-shaped channel or loop; and, a universal hose adapter, in straight or bent form, is used to connect the washing machine (or other device, such as a dishwasher) to the drain system rather than the hose adapter as shown in FIG. 4 (WC-3). Depending on which system embodiment is used, various methods may be used for installation of the system, system components and the kit(s).

In another preferred embodiment the system includes a 19″×14″×4″ injected molded plastic box complete with a finished trim ring and four “L” shaped ribbed plastic mounting brackets. The system housing preferably has two 2 ½″ diameter holes top and bottom which are located off center. These holes allow the center pipe assembly comprised of the top 2″ PVC pipe 200×800 to be in fluid communication with the atmosphere through a vent line and with the sewer system through a drain line. The central pipe manifold and top and bottom PVC pipes protrude 3″ above and below the box.

The top pipe is the vent pipe and is preferably connected to a new or existing drainage vent pipe with a standard off-the-shelf 2″ no hub connector. All pipe work preferably is ASTM clear PVD Schedule 40. The bottom pipe of the central pipe is coupled by a 2″ no hub connector to a new or existing drain pipe that is part of the domestic drainage sewer system. The no hub connectors facilitate ease of installation and removal of the complete NFWMOB for maintenance or replacement.

The central pipe manifold is comprised of a pipe with two pipe outlets or T-connections pointing or opening out in opposite directions and located at different levels. The top manifold outlet preferably is a 1″ PVC pipe outlet and is connected to a length of 1″ PVC pipe. This pipe is vertically oriented, runs in a downward direction parallel and adjacent to the central pipe. This 1″ pipe is then connected to a 90° PVC elbow and then to a short piece of 1″ PVC pipe, which is connected to a 1″ PVC 90° elbow. The 90° elbow is connected to a Universal Hose Adaptor (UHA).

The UHA is an adapter that enables a direct connection of the box to the discharge or drainage system of any standard size washing machine flexible drain hose. The drain hose is secured to the UHA by a stainless steel compression hose clip which is tightened to a standard rate of compression by a standard plumbers torque wrench, or by other conventional means such as hose clamps.

The lower part of the 2″ central pipe manifold is a 1 ½″ PVC pipe outlet that is connected by a short piece of 1 ½″ PVC pipe 150×3500 to a water level sensor or float switch. A circular sensor holder is positioned over the 1 ½″ pipe and preferably includes a magnetic sensor. Preferably an ISO PVC female adaptor is attached to the 1 ½″ pipe and to a 1 ½″ PVC male threaded plug. The plug includes an attached float mechanism, comprised of a nylon eyebolt screwed into the threaded plug and an off-the-shelf combination float and magnet that is hooked onto the nylon eyebolt.

During operation and in the event of blockage of the drainage system, blocked sewage begins to back up upstream because of continued use of toilets, sinks, washing machine, baths, showers etc. The sewage water begins to rise up the washing machine drain pipe and when it reaches the 1 ½″ T-connection the sewage water enters the float switch chamber and causes the float to rise. The float switch has a built-in magnet and when it has risen sufficiently close to activate the magnetic sensor, electrical power is shut off to a conventional Ground Fault Circuit Interrupter (GFCI), typically built into a conventional electrical socket, thus causing loss of power and shut down of the washing machine and its pump. The audible and visual alarm system is activated and the system's control sub-system prevents the washing machine from re-starting until the drain blockage is cleared, the water level falls, the switch also falls back to its normal position, breaks contact with the sensor and the start button is pushed by the user. Only then can the start button be reset and normal service resume.

The system's electronic control system includes a printed circuit board (PCB) that controls the GFCI receptacle, LED indicators, motorized valves, interior LED lighting, moisture sensors, float switch, audible and visual alarms, auxiliary battery fail-safe back up system, start-stop, reset and mute functioning and alarm notification. The GFCI receptacle and panel cover are integral to NFWMOB system and provide electrical power to the washing machine.

The motorized valves control flow of the hot and cold water into the washing machine and include a safety function. When a leak or flood is detected from any or all of the washing machine, flexible water supply hoses, washing machine drain hose or the UHA connection, or moisture sensors, the control systems shuts off electrical power to the entire NFWMOB system. The NFWMOB system is then placed in “Failsafe Mode” and the visual/audible alarms are activated. The motorized valves are automatically closed by the back-up battery, preferably a lithium battery. Electrical power cannot be restored to the GFCI, washing machine, moisture sensor and the motorized valves until the problem is fixed and the control box start button is manually reset.

Optionally, and for convenience two manually operated on/off valves are installed immediately upstream from the motorized valves so that the motorized valves can be isolated from the water supplies (for repair or replacement) without shutting off the main cold water inlet valve. Also the alarm mute button can be pressed by the user once the fault has been recognized. In the event of a prolonged power failure the NFWMOB system “Goes to Sleep”. In the event of a leak from a washing machine or associated equipment in a single family dwelling, apartment or condominium the NFWMOB system also has the capability to send an electronic message to the homeowner, building management, security and maintenance engineers' offices that a leak has occurred in that house or particular unit. The NFWMOB also has an interior panel LED lighting capability such that when the box's face plate or panel cover is removed a pressure switch is activated and illuminates the box interior with blue LED light. When the panel cover is replaced the pressure switch is depressed and the lighting goes off.

In another preferred embodiment, any of the above-described systems may be combined with a pair of most preferred, very strong washing machine hoses. These hoses, when used with the present system provide a significantly increased level of protection against water damage at and near an installed washing machine. The most preferred hoses are commercially available from Floodchek Corporation, as its Floodchek™ brand washing machine hoses.

In another alternate embodiment, any of the above-described embodiments may be packaged into a kit, available for retail sale and used to retrofit a previously installed washing machine connection. The kit may include not only the housing, internal plumbing, control and alarm circuit, but also a set of the Floodchek™ brand washing machine hoses to provide a complete no washing machine flood protection system.

These and other embodiments, features, aspects, and advantages of the invention will become better understood with regard to the following description, appended claims, and accompanying drawings.

### BRIEF DESCRIPTION OF DRAWINGS

The foregoing aspects and the attendant advantages of the present invention will become more readily appreciated by reference to the following detailed description, when taken in conjunction with the accompanying drawings, wherein:

FIG. 1A is a schematic diagram illustrating a preferred embodiment in a typical environment of use;

FIG. 1B is perspective view of the FIG. 1 embodiment showing some of the internal components in dashed lines;

FIG. 1C is a schematic drawing of the surge protection circuit of the FIG. 1 embodiment;

FIG. 1D is a front view of the cover plate for the surge protection circuit box of the FIG. 1 embodiment;

FIG. 1E is a list of components and reference numerals used in FIGS. 1A-1D;

FIG. 2 is a front elevation view of the FIG. 1 embodiment;

FIG. 3 is an elevation view of the FIG. 1 embodiment, taken at 90° from the FIG. 2 view;

FIG. 4 is a side view of the universal connection sub-system of the FIG. 1 embodiment;

FIG. 5 is an end elevation view of an alternate preferred embodiment;

FIG. 6 is front elevation view of the FIG. 5 embodiment;

FIG. 7 is a front view of the FIG. 5 embodiment;

FIG. 8 is a side view of the FIG. 5 embodiment;

FIG. 9A is a front, perspective view of the FIG. 5 embodiment, system with the front doors not shown;

FIG. 9B is a front view of the FIG. 5 embodiment with the front doors not shown;

FIG. 9C is an enlarged, front, cross-sectional view of the horizontally oriented float switch as shown in FIG. 9B;

FIG. 9D is a top, cross-sectional view of the horizontally oriented float switch as shown in FIG. 9B;

FIG. 10 is a exploded, front perspective view of the FIG. 5 embodiment;

FIG. 11 is a side view of the bent form, universal hose adapter of the FIG. 5 embodiment;

FIG. 12 is a side view of the straight form, universal hose adapter of the FIG. 5 embodiment.

FIG. 13A is a front, exploded view of an alternate embodiment flood prevention system;

FIG. 13B is an exploded view of the internal piping and float switch assemblies of the FIG. 13A embodiment;

FIG. 13C is a view of a trim ring and top plate for the FIG. 13A embodiment;

FIG. 14A is a front view, with the front cover removed, of the FIG. 13 embodiment;

FIG. 14B is a cross-sectional view of the float switch sub-assembly of the FIG. 13 embodiment, taken through line A-A of FIG. 14A;

FIG. 14C is a cross-sectional view of the float switch sub-assembly of the FIG. 13 embodiment, taken through line B-B of FIG. 14A;

FIG. 14D is a front view of the assembled FIG. 13 embodiment, with the front panel installed.

FIG. 15 is a high level, system block diagram of the control and indication sub-systems of the FIG. 13 embodiment;

FIG. 16 is an electrical schematic circuit diagram for the cold water valve driver of the FIG. 13 embodiment;

FIG. 17 is an electrical schematic circuit diagram for the hot water valve driver of the FIG. 13 embodiment;

FIG. 18 is an electrical schematic circuit diagram for the cold and hot water valve connections to the printed circuit board (PCB) of the FIG. 13 embodiment;

FIG. 19 is an electrical schematic circuit diagram for the valve open indicator light emitting diode (LED) of the FIG. 13 embodiment;

FIG. 20 is an electrical schematic circuit diagram for the valve close indicator LED of the FIG. 13 embodiment;

FIG. 21 is an electrical schematic circuit diagram for the drain alarm indicator LED of the FIG. 13 embodiment;

FIG. 22 is an electrical schematic circuit diagram for the floor moisture alarm indicator LED of the FIG. 13 embodiment;

FIG. 23 is an electrical schematic circuit diagram for the low battery alarm indicator LED of the FIG. 13 embodiment;

FIG. 24 is an electrical schematic circuit diagram for the system fault indicator LED of the FIG. 13 embodiment;

FIG. 25 is an electrical schematic circuit diagram for the audible alarm (beeper) driver of the FIG. 13 embodiment;

FIG. 26 is an electrical schematic circuit diagram for the processor, floor moisture sensor signal conditioning, and user input buttons of the FIG. 13 embodiment;

FIG. 27 is an electrical schematic circuit diagram for the processor programming connection on the PCB of the FIG. 13 embodiment;

FIG. 28 is an electrical schematic circuit diagram for the power supply, GFCI relay driver, and utility sense signal conditioning circuit of the FIG. 13 embodiment;

FIG. 29 is an electrical schematic circuit diagram for the auxiliary relay driver and relay contact connections to the PCB of the FIG. 13 embodiment;

FIG. 30 is an electrical schematic circuit diagram for the floor sensor connection to the PCB of the FIG. 13 embodiment;

FIG. 31 is an electrical schematic circuit diagram for the drain sensor connection to the PCB of the FIG. 13 embodiment;

FIG. 32 is an electrical schematic circuit diagram for the door panel LEDs of the FIG. 13 embodiment;

FIG. 33 is a block diagram for a preferred startup sequence of the FIG. 13 embodiment;

FIG. 34 is a block diagram for a preferred shutdown sequence of the FIG. 13 embodiment;

FIG. 35A is a block diagram for a preferred alarm conditions sequence for the drain sensor of the FIG. 13 embodiment;

FIG. 35B is a block diagram for a preferred alarm conditions sequence for the floor sensor of the FIG. 13 embodiment;

FIG. 36 is a block diagram for preferred alarm display and audible sequences of the FIG. 13 embodiment;

FIG. 37 is a block diagram for preferred normal operation, including close and open valve sequences, periodic cycling of the motorized water valves, and battery monitoring of the FIG. 13 embodiment; and,

FIG. 38 is a set of descriptions and symbols used in FIGS. 33-37.

Reference symbols or names are used in the figures to indicate certain components, aspects, and/or features shown therein. Reference symbols common to more than one figure indicate like components, aspects and/or features shown therein.

### BEST MODE FOR CARRYING OUT THE INVENTION

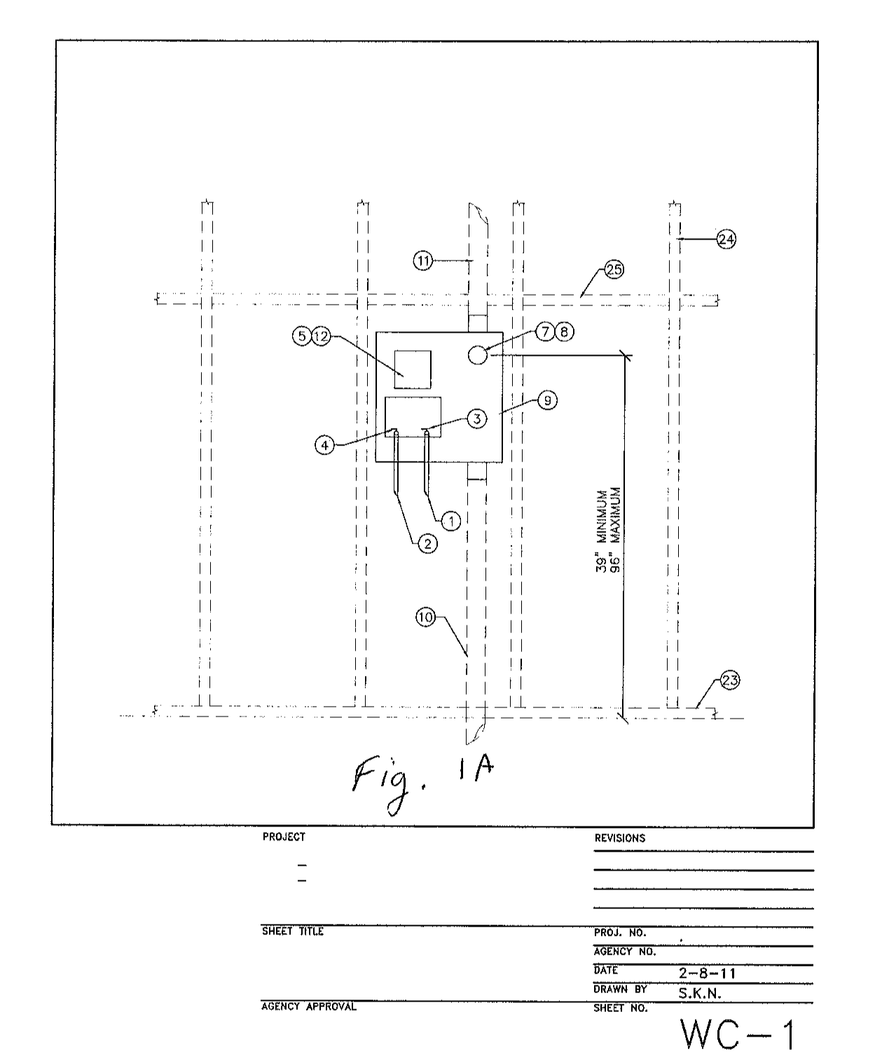

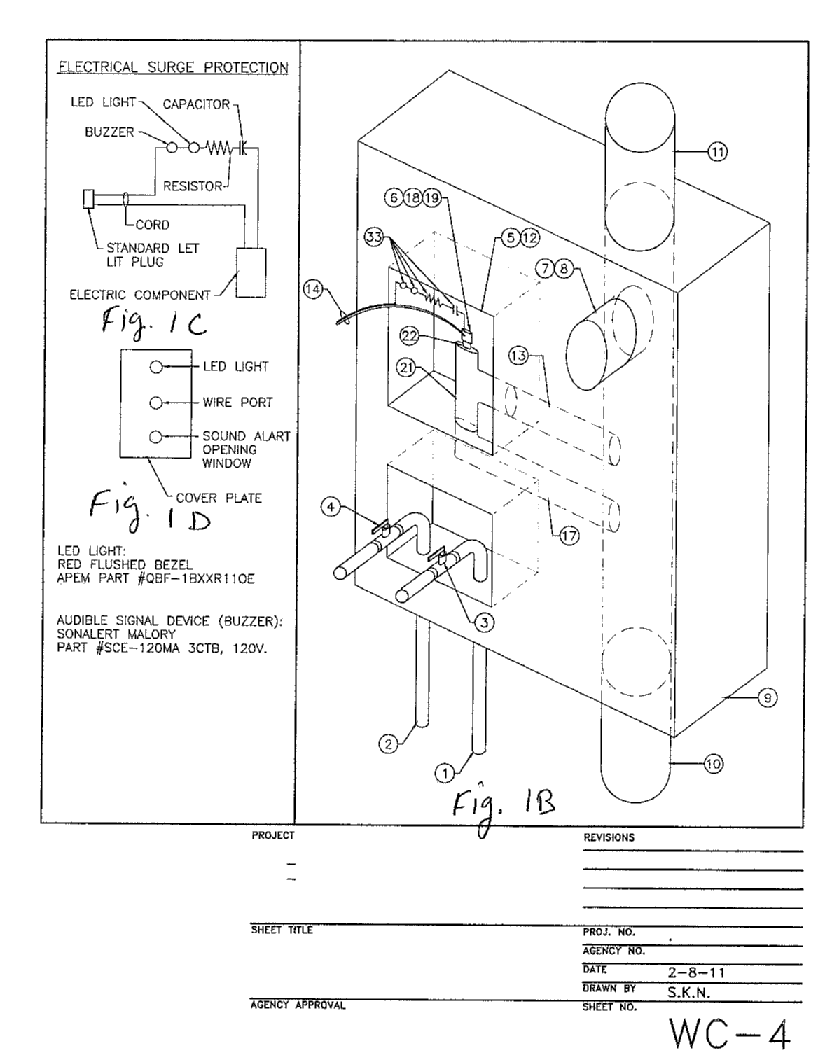

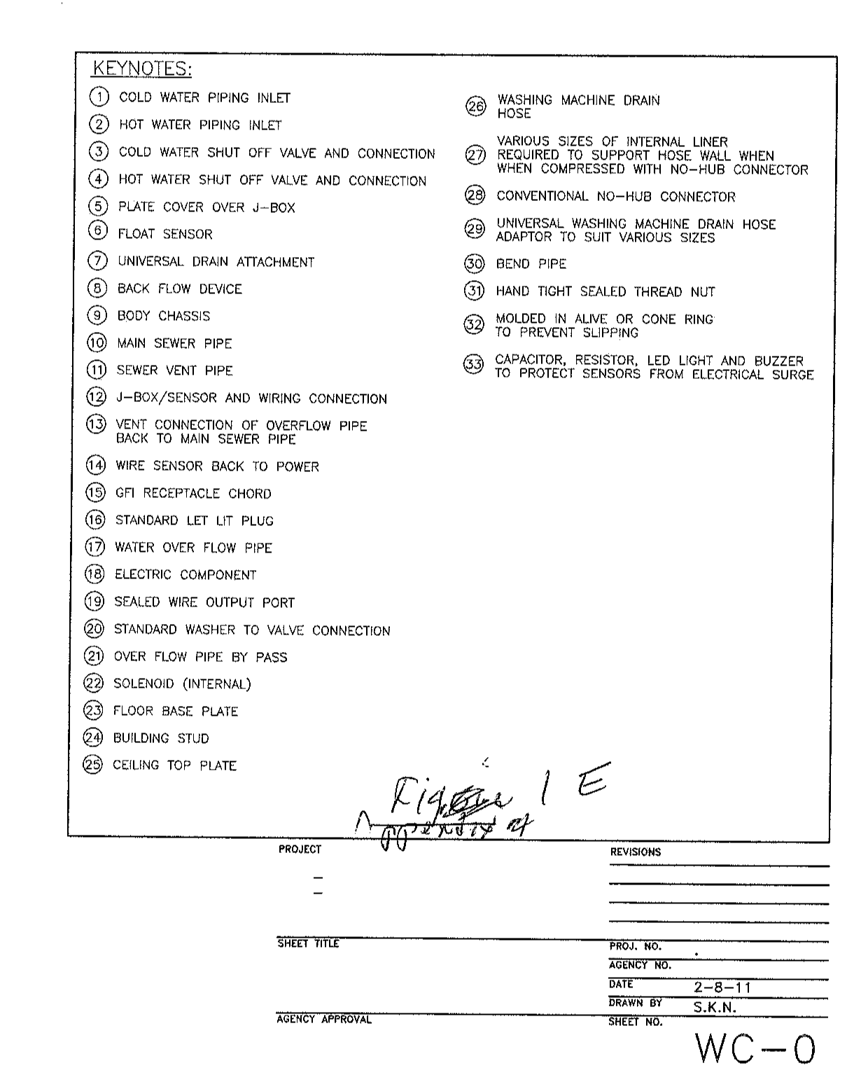

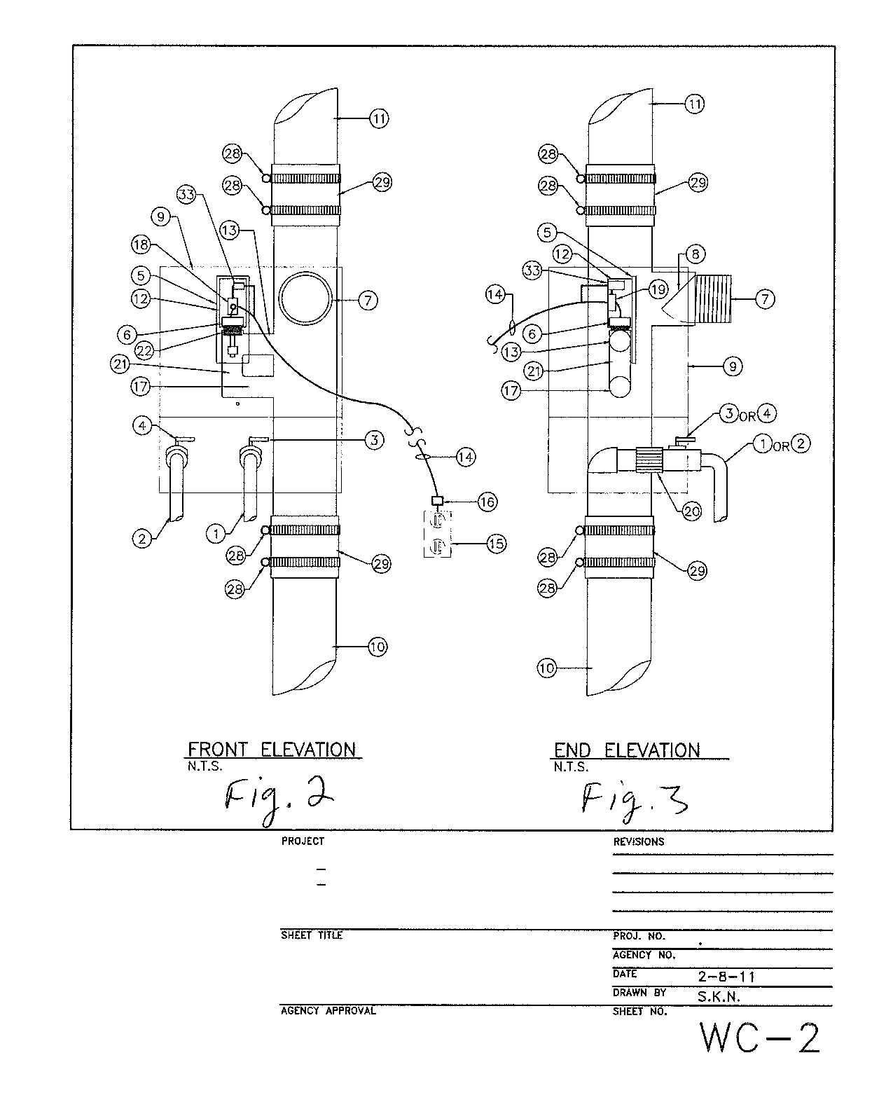

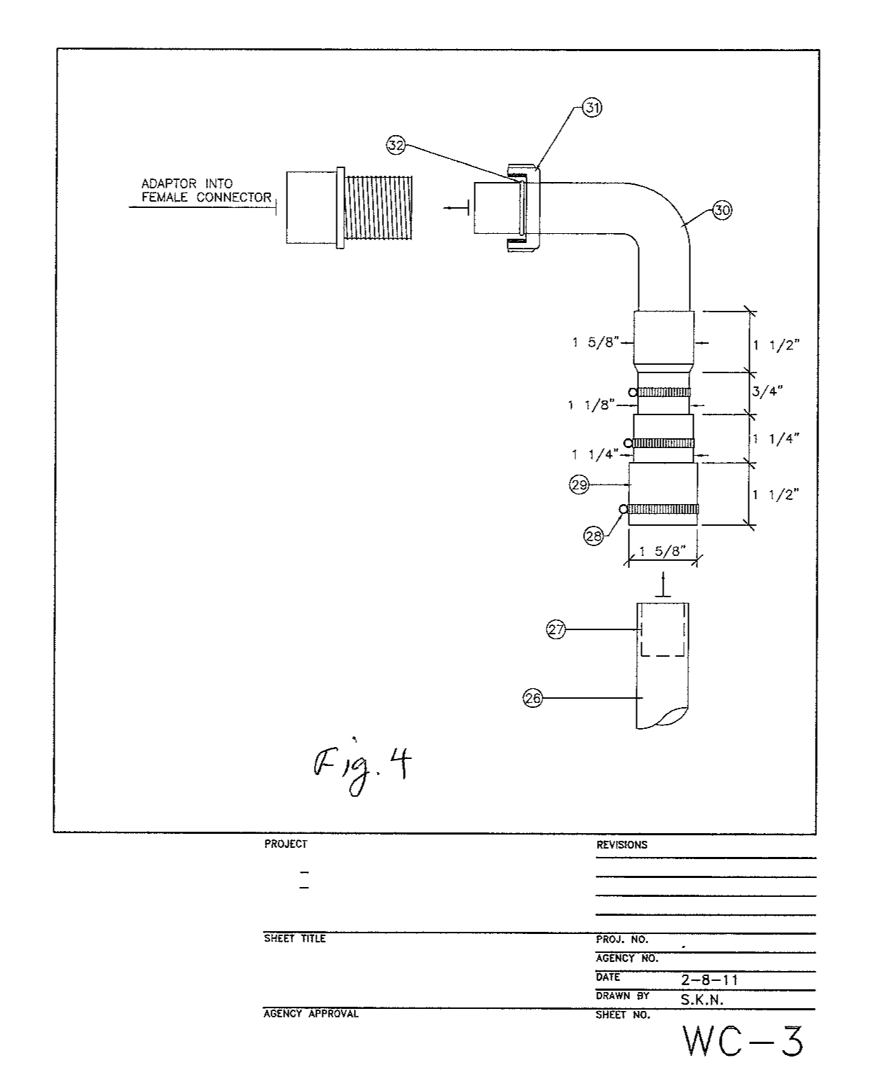

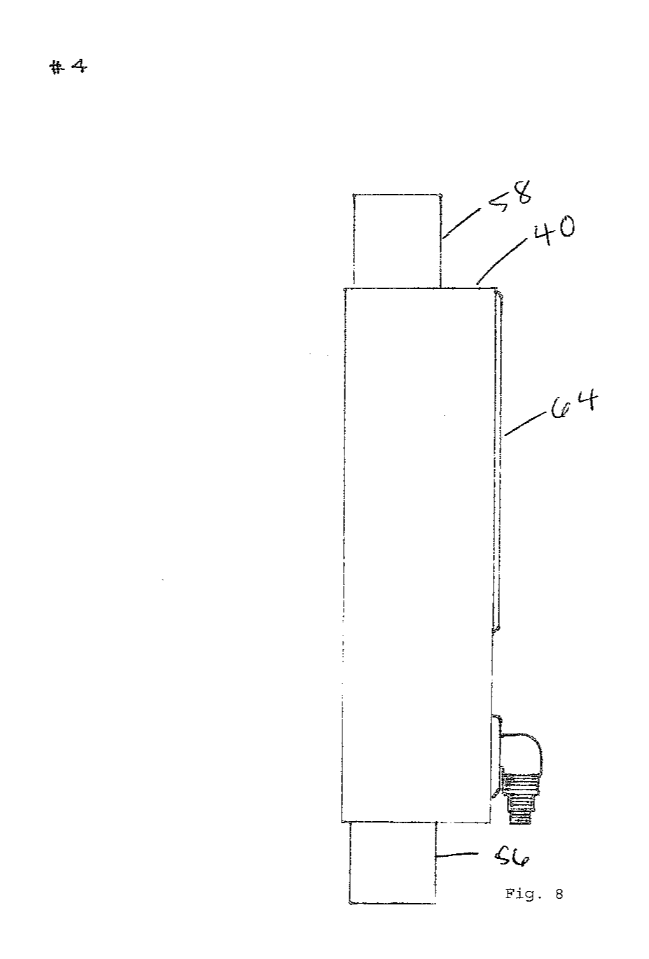

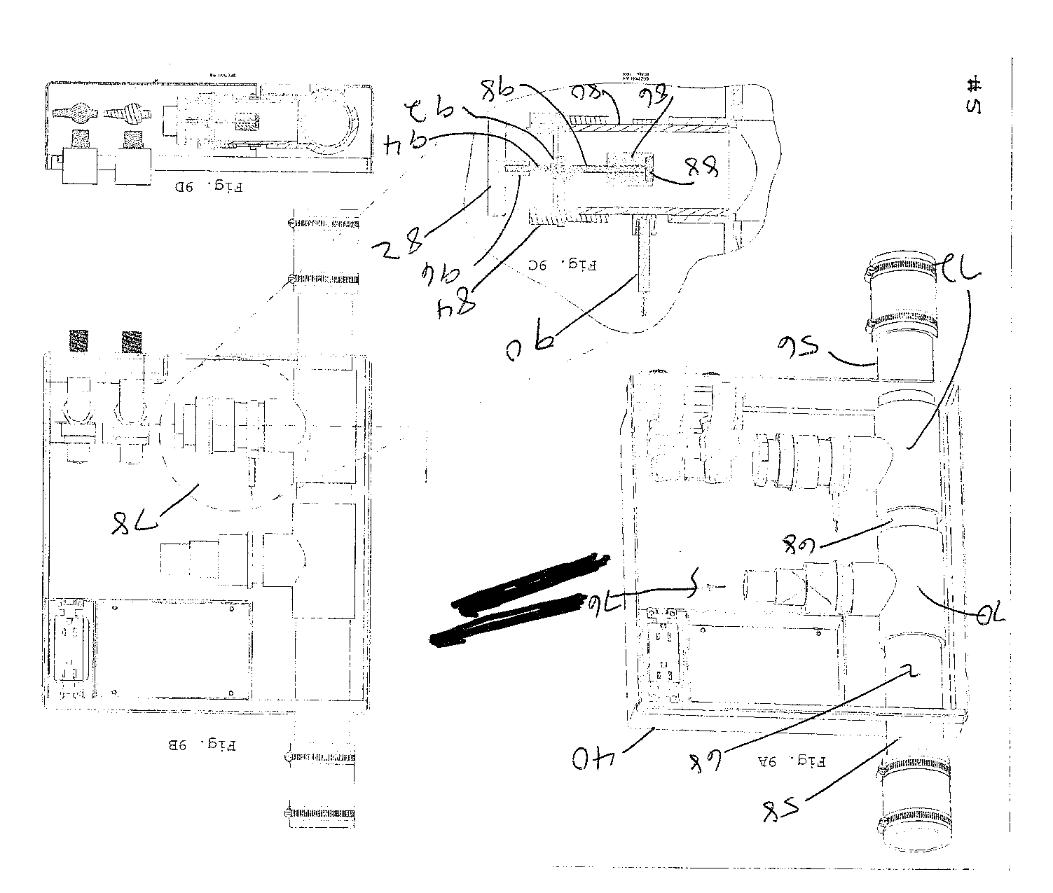

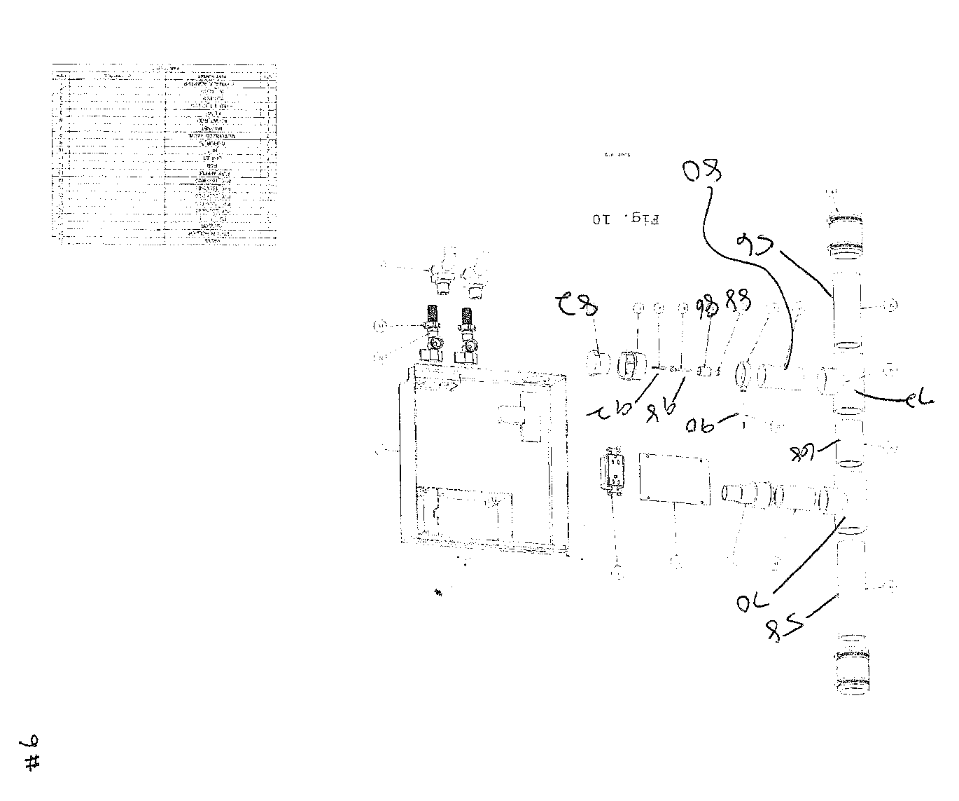

With reference to FIGS. 1-38 preferred embodiments of the present systems and methods will be described. In accordance with embodiments described herein, the present system prevents major flood damage by providing a sealed connection between the washing machine drain hose and the sewer line drain without inducing siphonage. The present system also includes sensors to detect drain line blockage and a sub-system that functions to shut-off the washing machine and stop pumping of waste water in order to prevent flooding.

Included herewith is a listing of components, referred to as FIG. 1E (WC-0) and that will be used in describing the system with reference to the various figures, referred to as WC-1 through WC-4. Referring to FIGS. 1-4 [WC-1] a preferred system includes a self-contained, easy-plumbed housing or body chassis 9, preferably of neat appearance, with finish trim to cover the joint between the box and surrounding drywall, not shown. The housing or chassis 9 includes water supply lines 1, 2, valving 1, 4, a backflow prevention sub-system, generally and preferably shown inside of the housing 9, a conventional J-box/sensor at 12 and a washing machine drain line inlet, shown as a universal drain attachment at 7. The water supply includes cold water piping inlet 1, hot water piping inlet 2, cold water shut off valve and connection 3, and hot water shut off valve and connection 4. Main sewer pipe 10 is shown connected to the chassis 9 and connected to a sewer line, not shown. Sewer vent pipe 11 is shown connected to the chassis 9 and leading to the atmosphere.

In FIGS. 1A [WC-1] and 1B [WC-4 Perspective], the body chassis 9 is shown in a typical installation within a studded wall, having vertically extending studs, one of which is shown at 24, and with horizontal cross members, one of which is shown as ceiling top plate 25. The chassis 9 is preferably made of a plastic material, and is typically mounted above floor base plate 23 preferably at a height between a minimum of 39 inches and a maximum of 96 inches. The washing machine may rest on the floor base plate 23 or on a raised floor, such as tiles.

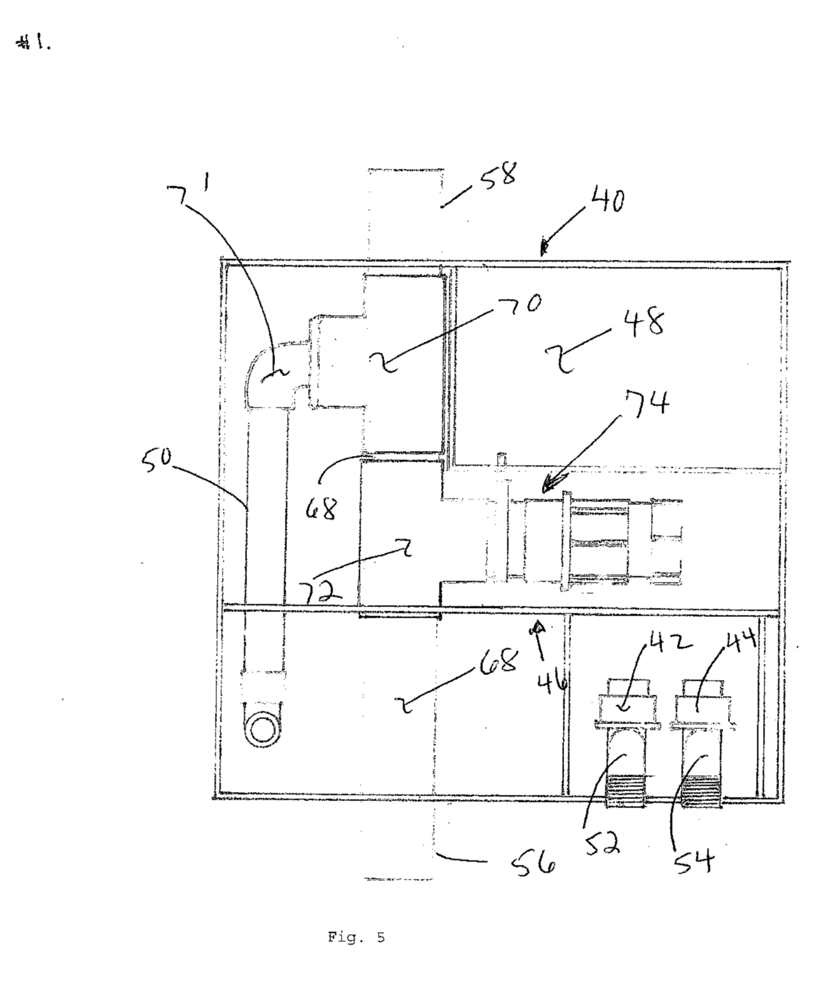

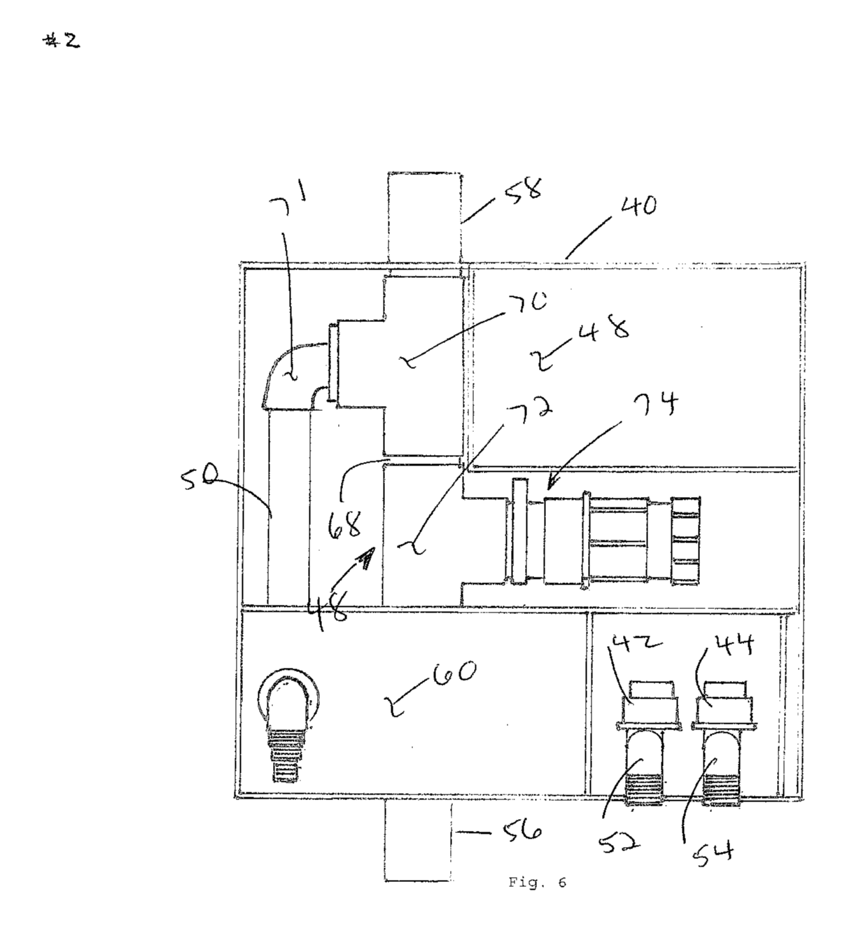

Referring to FIGS. 2 and 3 [WC-2 Front Elevation and WC-2 End Elevation], preferred system structures and operation of the system components inside of the chassis 9 will be described. Inside the chassis is a sub-system of pipe work, preferably using pipes having diameters of 2, 3 or 4 inches. An illustrative pipe, referred to as a T-pipe and not numbered, that may be made of conventional copper, PVC, etc., construction, extends vertically inside of the box from bottom to top, and preferably with a right angle, or T-connection at universal drain connection 7 to the washing machine drain line. The top of the pipe is adapted for connection to sewer vent pipe 11 and the bottom of the pipe is adapted for connection to the main sewer pipe 10. The system T-pipe is connected to the vent and sewer pipes with conventional no-hub connectors 28 and universal washing machine drain hose adapters, available in various sizes, and as shown.

Also referring to FIGS. 2 and 3 [WC-2 Front Elevation and WC-2 End Elevation] a back flow sensing and shut-off sub-system will be described. Positioned within the chassis 9 and on the T-pipe is a horizontally extending lower leg or T-junction, also referred to as a water overflow pipe 17. The pipe 17 connects to a vertically extending over flow pipe by pass 21. The pipe by pass 21 then connects to a horizontally extending pipe 13, referred to as a vent connection of the overflow pipe back to the main vertically extending pipe 13. In combination the T-pipe inside of the chassis 9 and the pipes 17, 21 and 13 form a bypass or C-shaped channel or loop in which water flowing upward from the sewer pipe 10 flows into the C. As will be further described, a float valve is positioned in the vertical leg of the C loop and functions to detect a flow blockage, trigger an alarm and/or to trigger shut down of the washing machine when activated by a high water level. The C loop functions to divert rising water resulting from a blockage downstream in the sewer pipe 10. In the event of a blockage and during operation of the washing machine, as the water rises, or backs-up, due to the blockage, that water flows into the loop and ultimately to a conventional float switch that includes a float sensor 6 and an internal solenoid 22. These components are positioned behind the housing cover 5. As will be understood, the J-box 12 provides a leak-proof housing for the float switch, alarm and controls to preserve electrical integrity.

In a sewer blockage back flow situation, as water continues to rise in the T-pipe and loop, it will cause the float to rise and contact float sensor 6 to actuate the electric component 18 of the float switch and trip the solenoid 22. Once the electric component 18 is actuated, i.e., a circuit is closed, preferably an alarm, visual and/or audible, is activated, and the washing machine is shut off. Once actuated, the back flow alarm and control sub-system transmits a signal via line 14, a line from the sensor to the main power through a conventional GFCI, shown connected to a standard socket or plug 16 and GFCI receptacle chord 15, which cuts off electric service to the washing machine or any other device connected to the electric outlet controlled by that specific GFCI.

A preferred float switch is commercially available from Omega Engineering, Atlanta, Ga., as its part # LVK-130 multi-level switch. The float switch is activated when the sewer line is blocked and water in the internal piping rises to a height sufficient to close the switch. The waste water in the drain will rise because of the continued discharge flow from the operating washing machine, and/or appliance(s) or plumbing sources discharging water into the drain. When the rising water contacts the float switch, which normally is in the “closed” position, the float will rise until it causes the switch to be in the “open” position. In the open position, the float switch allows electric current to flow to the GFCI receptacle which then automatically shorts or trips the GFCI, thereby shutting off electrical power to the washing machine. With the washing machine disabled, the GFCI can only be re-set when the drain blockage is cleared. The waste water then flows down into the sewer and the float on the float switch drops back to its closed position. The GFCI reset button can then be pressed to return electrical power to the washing machine. It is envisioned that other conventional back flow and power cut off sub-systems may be used in the present system. Also schematically shown at 33 are a capacitor, resistor, LED light and buzzer to protect the sensors from electrical surge and provide the alarms.

With reference to FIG. 3 [WC-2 End Elevation], a view of the interior of the preferred embodiment is shown, but in a view that is 90° from the view of FIG. 2 [WC-2 Front Elevation]. Standard washer to valve connection 20 is shown for the water service, and a sealed wire output port 19 is shown for the wire leading from the float valve to the GFCI. A back flow prevention device, preferably a check valve is shown at 8, where it is positioned at an inlet of the chassis or housing 9. Water draining from the washing machine flows from right to left through the connection shown as universal drain attachment at 7. The back flow prevention device 8 is preferably a conventional check valve, pivoted at the top so that it is pushed open by the flow of water being pumped out of the washing machine, into the unit, and subsequently the drain. In FIG. 3 [WC-2 End Elevation] the valve is shown in its open position, as if water was flowing into housing or chassis 9. The normal position of the valve is closed due to gravity. If a blockage occurs downstream of the valve 8, water backs up until it reaches the float valve, and keeps rising until it trips its solenoid and shuts off the washing machine as described above. Even though the washing machine or similar equipment such as a dishwasher would be isolated, water in the drain could continue to rise. In the event that backed-up water reaches the backflow prevention device or check valve 8, the pressure created by the rising water and gravity forces and keeps the diaphragm of the valve 8 closed. The one-way backflow valve 8 thereby prevents waste water and possible effluent from entering the washing machine. When the blockage is remedied and normal operating conditions resume, the washing machine or similar equipment can start working immediately with no time consumed by clean-up, maintenance, repair, replacement, or water damage due to flooding.

With reference to FIG. 4 [WC-3], the present system preferably includes a novel hose adaptor that has been modified from a commercially available adaptor from the Sealed Unit Parts Company Inc., (SUBCO), Allenwood, N.J., as its model SU-SSD6 drain hose. Whereas the conventional SUBCO adapter relies solely on friction to form the connection, the novel adapter described herein relies on a compression connection resulting from screwing the nut 31 onto the female end of the connector and to compress the ring 32, together which form an extremely tight connection or joint. The preferred adaptor includes an elbow or bent pipe 30 having a male end, a female connector (not numbered), an internal threaded nut 31 and a molded, in line or cone ring 32. The elbow or pipe 30 is preferably a 90-degree bend plastic pipe with one end adapted to be inserted into the female connector, which in turn is positioned on the housing or chassis 9, at 7 as shown in FIG. 3 [WC-2]. The male end of the adapter is inserted into the female connector, and the nut 31 is rotated to tighten and compress the ring 32 against the shoulder (not numbered) on the connector to form a compression joint and to prevent leaking and slipping.

At its upstream end the novel adaptor is connected to the washing machine drain hose 26 using an appropriately sized novel internal liner 27. The novel liner 27 is available in various sizes and is used to support the hose wall when compressed together with a connector. The preferred connecter is of the no-hub type of compression ring, which is tightened with a torque wrench to achieve a proper compression. Other types of compression connections may be used, so long as they provide for adequate compression to form a seal between the washing machine discharge and the adaptor. The novel adapter 30 is joined, preferably during manufacture, to a flexible, soft rubber telescoping adapter pipe having differing diameter collars. These collars are sized to receive drain hoses of many conventional washing machines. The upstream end of the novel adaptor, shown at the bottom right of FIG. 4 [WC-3] has been further modified to include tightening clamps attached to the soft rubber collars. These clamps are preferably movably affixed to the soft rubber telescopic tubes during manufacture. Also, a selection of different diameter rigid plastic inserts or “liners” are provided. For a specific installation, an appropriately sized liner, that is, a liner having an appropriately sized diameter is chosen and then inserted into the washing machine drain hose discharge end. The insert or liner supports and strengthens the discharge end of the hose. The discharge end of the hose is then inserted into the telescopic part of the novel adaptor until it reaches and enters one of the collars of a corresponding or similar diameter section of the rubber tubes until a snug fit is achieved. Pressure is applied on the tightening clamp, preferably by use of a torque wrench. As pressure is applied to the rubber collar by tightening the clamp, an equal and opposite force is exerted by the rigid insert or liner. This results in the rubber collar being compressed under relatively high pressure and onto the washing machine drain hose and the liner, making a very strong, water-tight and, for practical purposes, unbreakable joint.

With reference to FIG. 1A, 1B, 1C and 1D [WC-4 Electrical Surge Protection] the electrical surge protection system is shown. The system includes a circuit in parallel with the line 14 from the float switch to the GFCI receptacle, and, in series a capacitor, LED light and buzzer to provide an audible alarm. The LED light is preferably a red, flushed bezel, commercially available light, APEM part # QBF-1BXXR11OE. The buzzer is preferably Sonalert Malory part # SCE-120MA-3CTB, 120V. With reference to FIGS. 1A, 1B and 1D [WC-1 and WC-4 Perspective] a preferred configuration on the cover plate 5 of the LEF light, wire port, and buzzer opening, or window is shown.

The preferred embodiment may include a one-piece mixing valve (not shown) with a shut-off. The hot and cold water inlets preferably each have a two-foot length of ½″ annealed copper pipe already soldered to the valve. The copper pipes are preferably annealed to make them more malleable. Due to the annealing process, the annealed water service pipes are relatively easily bent by hand for ease of installation and also to minimize potential damage to the system due to excessive force exerted during the installation process.

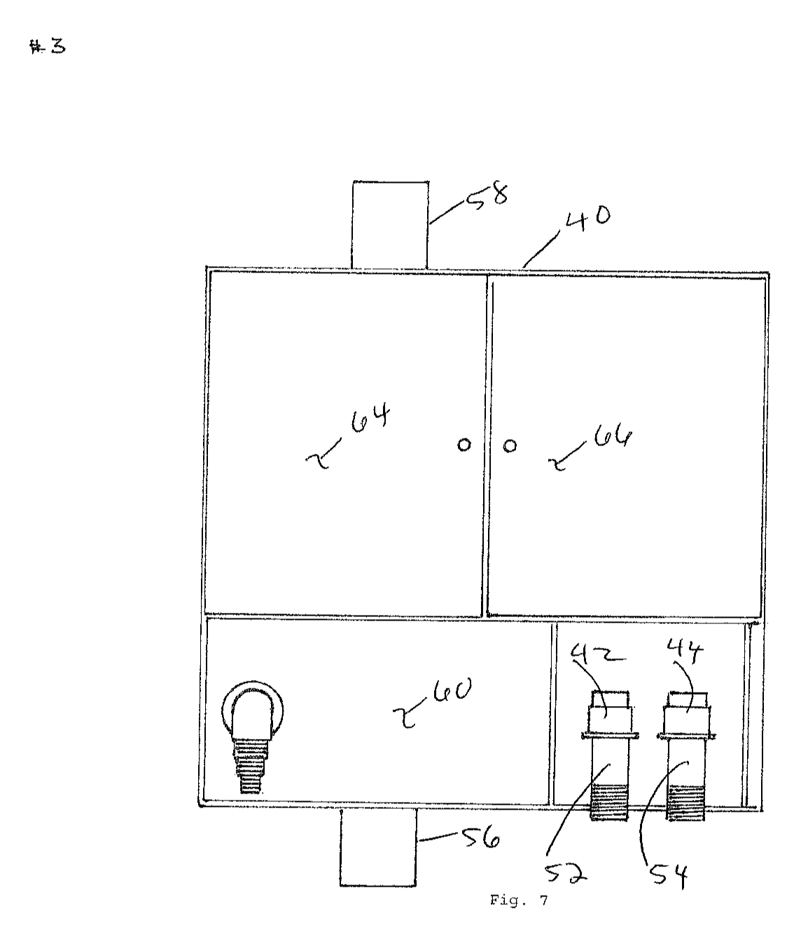

Referring to FIGS. 5-12 an alternate preferred embodiment washing machine flood protection system will be described. Referring to FIGS. 5-8 and 10, the system preferably includes a self-contained, easy-plumbed plastic housing or box 40, preferably of neat appearance, with finish trim to cover the joint between the box and surrounding drywall, not shown. FIG. 10 is an overall, exploded view of the mechanical components of the FIG. 5 embodiment. The box 40 includes water supply valving shown at 42 and 44, a backflow prevention sub-system 46, a control sub-system positioned inside of a conventional J-box at 48 and a washing machine drain line inlet 50. FIG. 6 shows a cover panel 60 positioned over that part of the sub-system 46 in which the washing machine discharge water enters via inlet 50. Valve 42 is connected to hot water service line 52 and cold water line 44 is connected to cold water service line 54. Drain 56 shown connected to the box 40 and connected to a sewer line, not shown. Vent 58 is shown connected to the box 40 and leading to the atmosphere. In FIG. 7, left and right cover panels 64, 66, respectively, are shown. The panels may be hinged or removably fastened to the housing with conventional fasteners, such as screws, snaps fittings, etc. The FIGS. 5-12 embodiment box 40 is adapted for a typical installation within a studded wall, as generally shown in and described with respect to FIGS. 1A-1D.

Referring to FIGS. 5, 6 and 9A-9D, structures and operation of the sub-system 46 will be described. Inside the box is a sub-system 46 of pipe work, preferably using conventional pipes having diameters of 2, 3 or 4 inches. An illustrative pipe 68, that may be of conventional copper, PVC, etc., construction extends vertically inside of the box from bottom to top, and preferably with a right angle, or T-connection 70 to the washing machine drain line. The top of the T-connection 70 is adapted for and in used in connected to sewer vent pipe 58 and the bottom of T-connection 70 connect to a second T-connection 72, to back flow sensing and shut-off sub-system 74 is connected. The bottom of T-connection 72 is adapted for and following installation is connected to sewer drain line 56.

Referring to FIGS. 9A-9D, back flow sensing and shut-off sub-system 74 will be described. FIG. 9A shows the relative positions of the pipe 68, T-connection 70, T-connection 72, the water inlet valves and lines, the J-box and GFCI connector inside of housing 40, and conventional no-hub, double band, screw-threaded connections to the vent line and to the sewer drain line, respectively. FIG. 9A also shows the relative positioning of the sub-system 74 within the housing 40 as in the lower part of the housing 40, above the sewer drain line 56 and below the T-connection 70.

FIG. 9A also shows an alternate embodiment of a washing machine drain inlet connection 76, which may be used, but is not preferred. The inlet connection 76 is shown entering the T-connection 70 from the right side, directly above the sub-system 74. While the vertical position of the T-connection 70 remains the same in the FIG. 5 embodiment, the inlet orifice is rotated 180 degrees from the position as shown in FIG. 9A. Thus, the preferred positioning of the T-connection 70 is as shown in FIGS. 5-7, that is, with the middle orifice open to the left for receiving washing machine discharge water.

Referring to FIGS. 9B-9D, sub-system 74 includes a horizontally extending, magnetically operated float switch 78. Float switch 78 includes a tubular casing 80, end cap 82, collar 84, float 86, magnet 88, sensor 90, float hook 92 and end cap hook or eyelet 94. The casing 80 is preferably glued into the T-connection 72 as shown in FIGS. 9A-9D, and the sensor 90 is fastened to the top of the casing 80, such as for example by gluing or press-fitting it into a cap which is then glued to the casing 80. The end cap 82 includes a center extension member, preferably internally threaded and into which a hook or eyelet is threaded. Magnet 88 is positioned inside of float 86, and is fastened by conventional means to hook 98, which is then connected to the hook or eyelet 94. As may be apparent, during operation and in the event of rising water level caused by sewer line blockage, as the washing machine discharge water level continues to raise it will flow into the casing 80, contact float 82 and cause the float to rise with the rising water level. When the float 82 rises to a height close to the sensor 90, a signal is sent to the control circuitry and closes a circuit. to shut the valves, remove power to the washing machine to shut it off and to trigger the back flow alarm. More specifically, and in a way similar to that shown and described with respect to the FIGS. 1-4 embodiment, the control sub-system transmits a signal via an electrical signal line a conventional GFCI, which in turn cuts off electric power to the wall electrical receptacle 58 and which in turn cuts off power to the washing machine or any other device connected to that specific GFCI. Preferably, the GFCI can be re-set only when the drain blockage is cleared and the float switch circuit is returned to its open position. Other conventional back flow and power cut-off sub-systems may be used in the present systems.

With reference to FIGS. 5 and 6, side views of areas of the interior of the preferred embodiment, float switch 78 is shown positioned in T-connection 72, which is below T-connection 72 inlet, through which the washing machine discharge water enters the pipe 68. J-box cover 48 is shown in FIGS. 5-6 and cover 60, over the washing machine discharge water inlet to the box is shown in FIG. 6. As will be understood, the J-box provides a leak proof housing for the alarm and control circuitry to preserve electrical integrity. Preferably a check valve, as shown and described with respect to the FIGS. 1-4 embodiment, is also including in the washing machine discharge water line into the housing 40 of the FIGS. 5-12 embodiment. The check valve is positioned at the inlet of the T-connection 70 in the connection, in the elbow 71, or as a separate valve component in the line between the T-connection 70 and the elbow 71. During normal operation water discharged from the washing machine flows left to right through the connection 70 as shown in FIGS. 5 and 6. The check valve is preferably a conventional check valve, pivoted at the top so that it is pushed open by the flow of water being pumped out of the washing machine, into the housing 40, and subsequently the drain. The normal position of the check valve is “closed” due to gravity. If a blockage occurs downstream of the housing 40 water backs up until it reaches the float switch sub-assembly 74, and keeps rising until float switch 78 switch is tripped, and shuts off the washing machine as described above. Even though the washing machine or similar equipment such as a dishwasher then would be isolated and shut off, water in the drain could continue to rise. In the event that backed-up water reaches the backflow or check valve, the pressure created by the rising water and gravity forces and keeps the diaphragm of the check valve closed. The one-way backflow valve thereby prevents waste water and possible effluent from entering the washing machine. When the blockage is remedied and normal operating conditions resume, the washing machine or similar equipment can be started immediately, and with no time consumed by clean-up, maintenance, repair, replacement, or water damage to the machine due to sewage line back-up flooding.

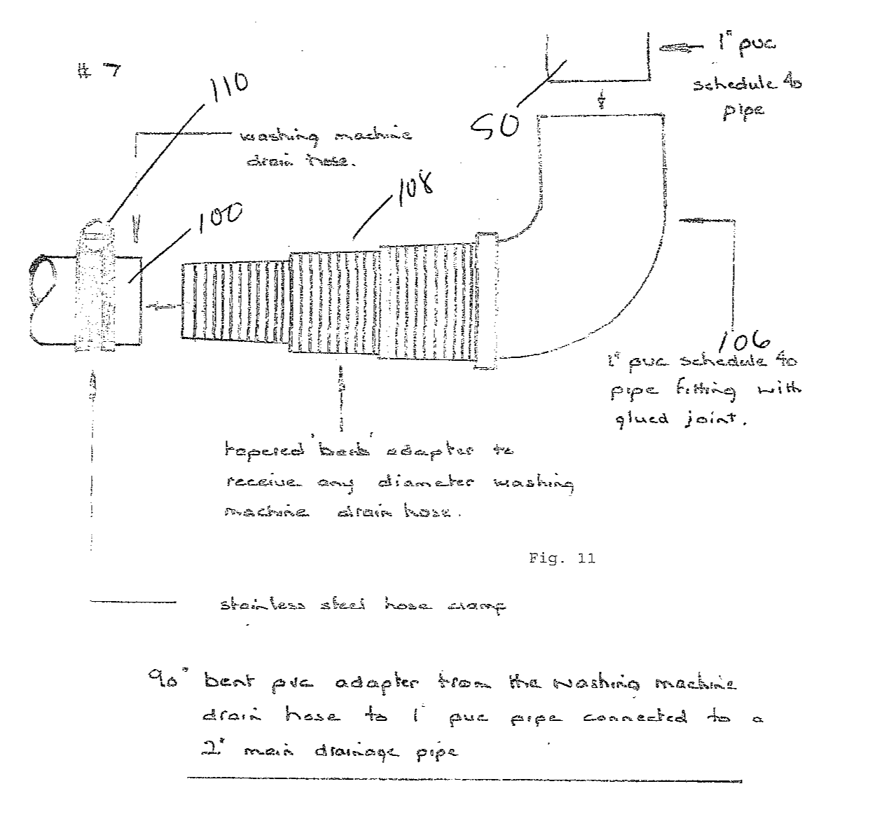

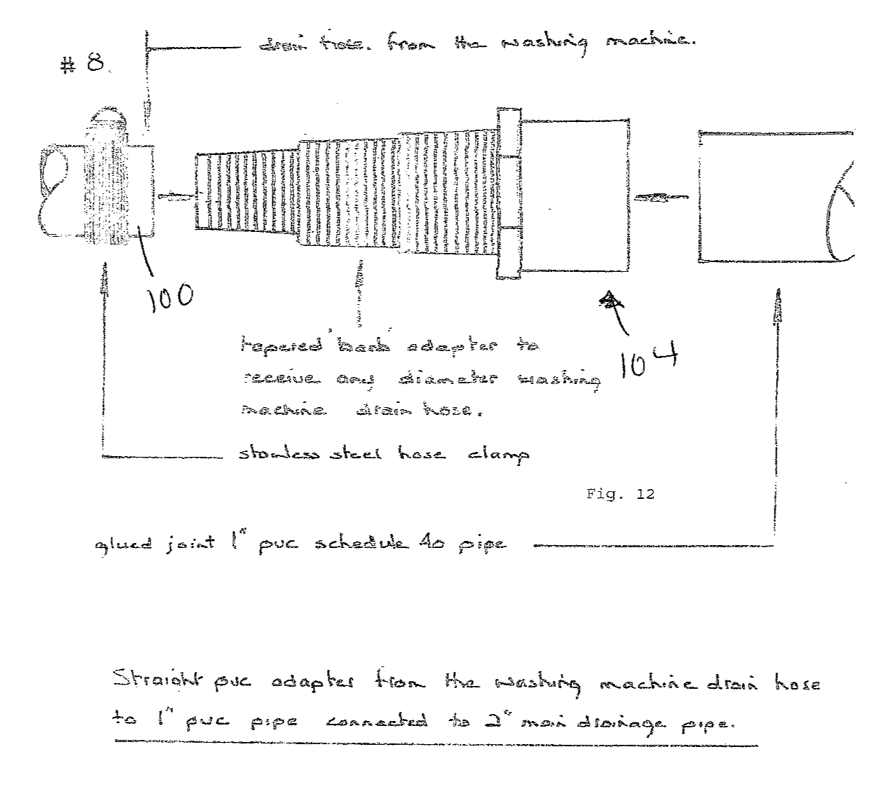

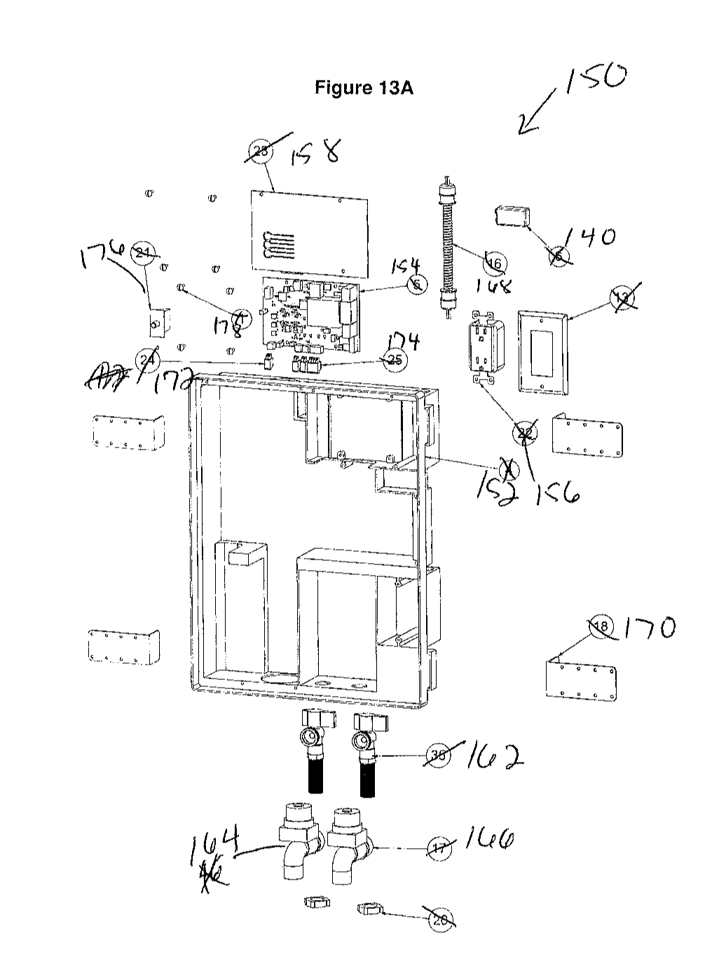

With reference to FIGS. 11-12, the FIG. 5 embodiment also preferably includes an alternate universal hose adapter (UHA) or connection that is positioned between the washing machine discharge line 100 and the inlet line 50 in the housing 40. Preferably the UHA is made of PVC; schedule 40 fitting that connects a washing machine flexible drain hose to a 1-inch PVC schedule 40 pipe that is part of the flood prevention system housing. Most preferably, the system housing measures 14″×14″×4″ so that it can be recessed into a plumbing wall (for standard US residential construction) or be surface mounted. The adapter may be a 90° bend adapter 102 as shown in FIG. 11, or a straight adapter 104, as shown in FIG. 12. The bend adapter 102 includes a 1-inch PVC, schedule 40 pipe fitting 106 with a glued joint that at one end is glued to the pipe 50 inside of the housing 40. At its other end, the bend adapter includes a tapered, threaded multi-barb member 108 that has several standard diameter threaded portions that enable the adapter 102 to receive any conventional washing machine drain hose. Once inserted into the washing machine discharge line or hose 100 at the corresponding barb of the member 108, the hose 100 is firmly fastened to the member 108 with a conventional, stainless steel hose clamp 110, with the head of the clamp's screw shown but not numbered. Other types of clamps may be used, such as for example a clamp that requires tightening with a plumbers torque wrench. Referring to FIG. 12, the straight connector 104 includes tapered barb member 112, which is identical to the tapered barb member 108, of FIG. 11, except of course that it is straight rather than bent. It is readily apparent that the adapters may be made with bends other than 90°, that different threads, different diameter barb members may be used, and that the adapters may be made of a unitary construction or may be assembled from component parts such as a collar that is threadedly connected to the bards. All of the PVC piping may be clear piping so that visual inspection may be made of the interior of the system. The electrical control system may be as described above with respect to the FIGS. 1-4 embodiment.

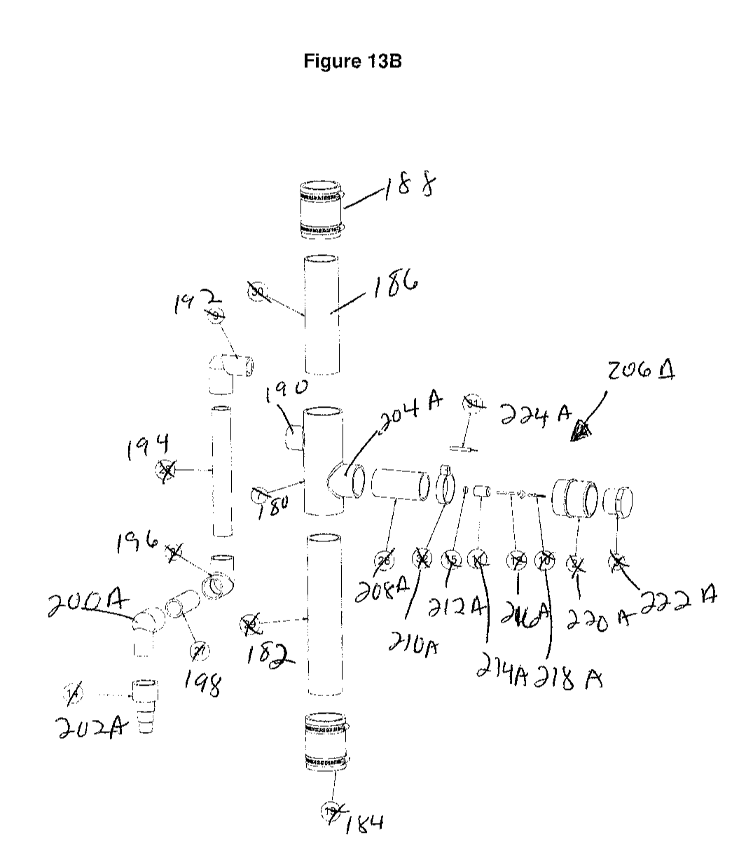

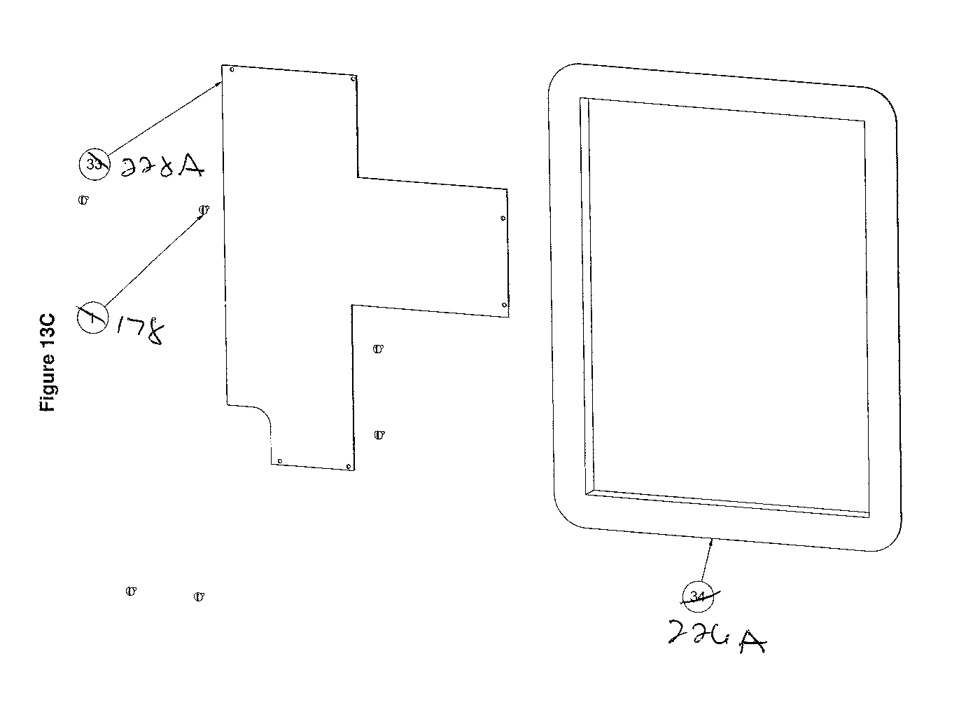

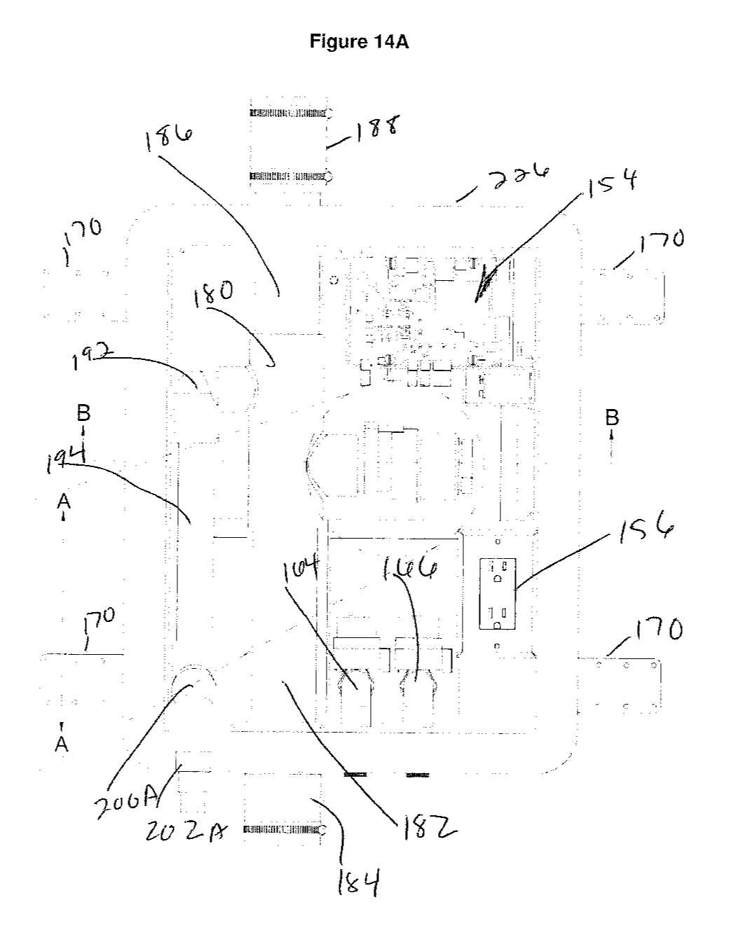

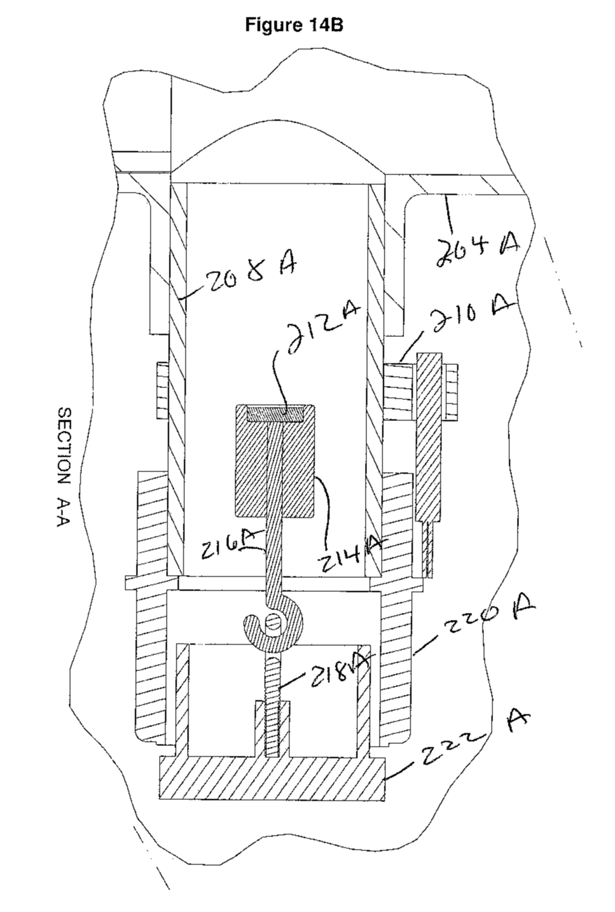

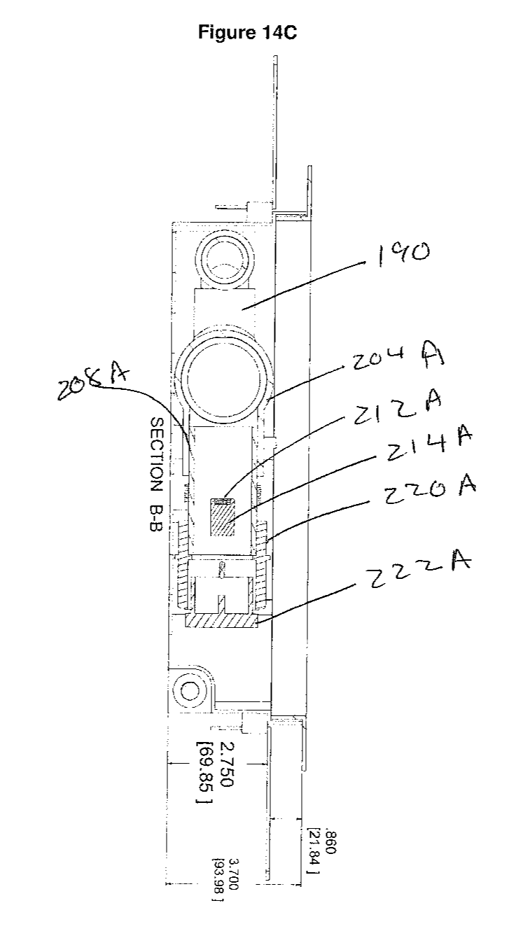

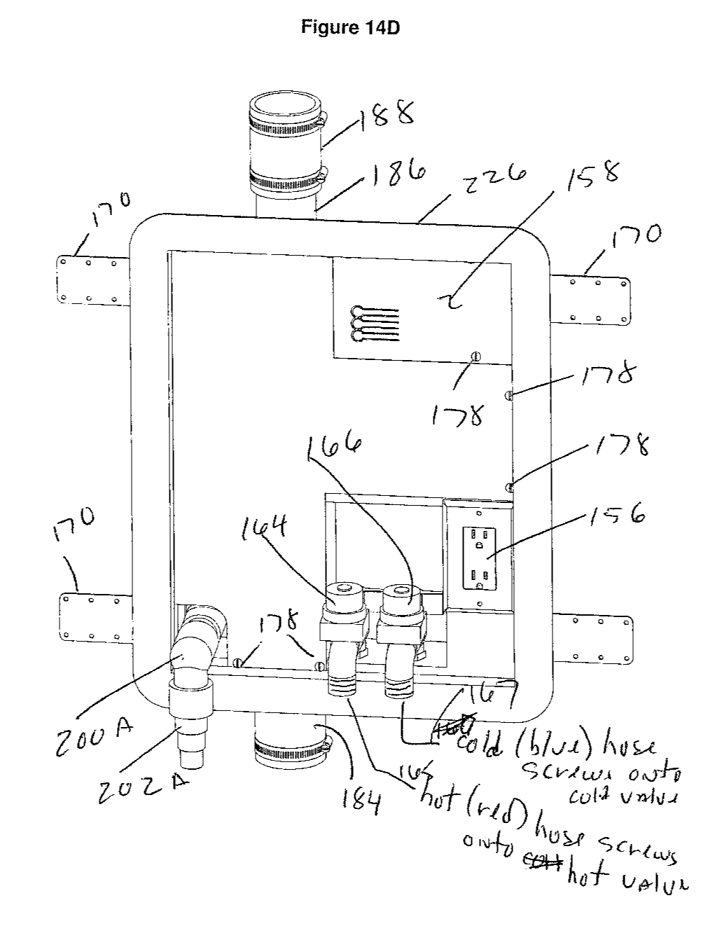

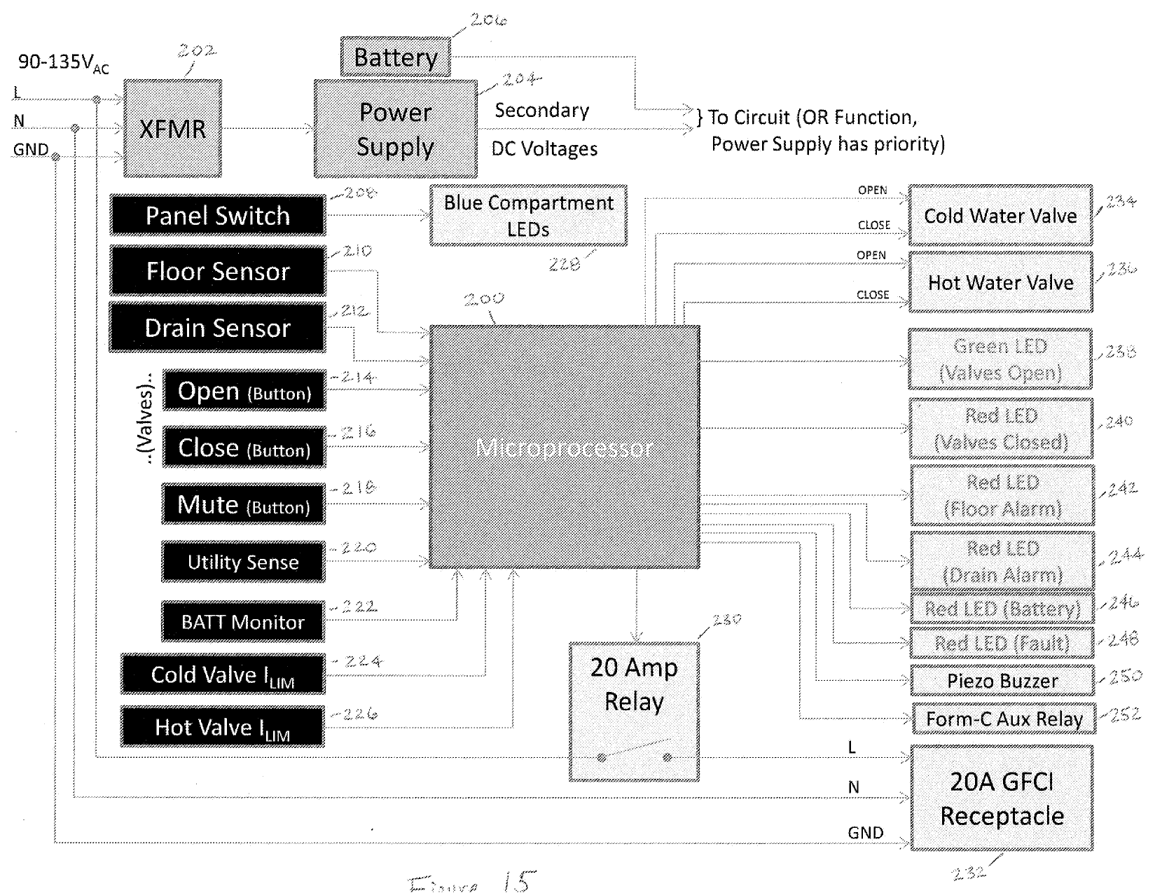

Referring to FIGS. 13-14 the mechanical housing and related housing components of another alternate embodiment 150 of the flood prevention system will be described. The system includes housing or box 152, printed circuit board (PCB) or chip 154 on which the electronic control and indicator circuits are positioned, electrical outlet 156 and its cover plate (not numbered), circuit board panel or cover 158 and battery 160, preferably a 9-volt battery. Also shown in FIG. 13A, collectively, are hot and cold water supply hoses and manual valves 162 for each supply hose. Motorized hot water and cold water control valves 164, 166, respectively are shown, together with their nuts, not numbered. Also shown are MC cable 168, mounting brackets 170, Phoenix brand plugs 172, 174 and reset switch 176, and panel mounting trusses 178. The housing 152 is preferably formed with several compartments, each of which contain certain components and sub-systems, such as the PCB, the inlet piping for washing machine discharge water, the float switch, vent and drain lines and the battery.

As shown in FIG. 13B, the heart of the plumbing sub-system includes a central, double T-connection PVC pipe 180, a lower extending drain pipe 182 that is connected at its top end to, or unitary with, pipe 180, and is also preferable of the same material and internal diameter. The lower end of drain pipe 182 is connected to a conventional sewer line (not numbered) via a conventional connector, such as a double hose clamp connector 184, and functions as a flow path for washing machine discharge water to flow from the washing machine to the sewer. The upper end of pipe 180 is connected to, or unitary with vent pipe 186, which in turn is connected a conventional vent pipe (not shown) via conventional connector 188, preferably of the same design as used for the connector 184.

In the FIG. 13 embodiment the pipe 180 includes two T-connections, each extending outward at 90° from the pipe 180, and preferably in opposite directions as shown. Preferably, the upper T-connection 190 opens toward the adjacent wall (right hand side wall as viewed from the front of the box 152), and is adapted to be connected to the washing machine water discharge line or hose. The T-connection 190 is in turn connected to an upper, right-angle elbow 192 which functions to change the direction of discharge water flow. Elbow 192 is connected to pipe 194 that extends vertically downward toward and connect to a lower, right-angle elbow 196, that again changes the direction of water flowing into the system from horizontal to vertical. Elbow 196 is connected to a short pipe 198, and short pipe 198 is then preferably connected to another right-angle elbow 200A. Elbow 200A is preferably connected to a UHA 202A, as described and shown in detail above. A straight UHA is shown in FIG. 13B.

Extending from the pipe 180 and into the interior of the housing 152 is T-connection 204A. The T-connection 204A is then connected to the float switch sub-assembly 206A, that includes pipe or pvc connection 208A, sensor holder 210A, magnet 212A, float 214A, float rod 214A, nylon eyebolt 218A, female adapter 220A, end cap or plug 222A, and magnetic sensor 224A, all of which components and sub-assemblies operate and function as described above. FIG. 13C shows a preferred trim ring 226A for the box 152, top plate or panel 228A and the trusses or screws 178A.

Further details of the float switch sub-assembly of the FIG. 13 embodiment are shown in FIGS. 14A, 14B and 14C. FIG. 14A illustrates the positioning of various sub-assemblies or sub-systems within the housing 152 and the various components and their functions are as described above in greater detail. FIG. 14B is a side cross-sectional view of the float switch as in the assembled system and taken through line A-A, including its various components as described above. FIG. 14C is a top cross-sectional view of the float switch as in the assembled system and taken through line B-B.

FIG. 14D illustrates the assembled system of the FIG. 13 embodiment, with the cover panels or plate screwed in place. FIG. 14D also illustrates another alternate embodiment, in which the system includes a set of high strength hoses 165 and 167 that connect the building water supply to the washing machine inlet valves 164 and 166. The preferred hoses used in this novel combination are available from Floodchek Corporation, Oliver Springs, Tenn., as its Foodchek™ brand washing machine hoses The hoses are color coded blue, for cold, and red, for hot, and installed as illustrated in FIG. 14D.

In another preferred embodiment, any of the above systems may be provided in a kit, packaged and suitable for retail sale to consumers for new construction or retrofitting existing construction. In these embodiments, the kit(s) preferably include a set of the Floodchek™ brand hoses, to provide a superior level of protection against water leaks and water flooding as described above and flooding that is due to faulty, worn out or damaged water supply hoses.

The FIG. 13 system preferably includes a floor sensor (not shown) that detects water on the floor at the location of sensor, and a drain sensor (not shown) that detects water in the drain from the washing machine. The sensors are conventional and commercially available, as detailed in the description of the electrical circuits below.

With reference to FIG. 15, a block diagram of the monitoring and control circuitry for the FIG. 13 embodiment is shown. A processor 200 with embedded firmware provides all necessary monitoring and control algorithms. The power conditioning section consists of three main components, namely a main transformer 202, a power supply 204, and a backup battery 206. Power supply 204 embodies a subsystem which contains several DC/DC converters and generates multiple power rails required by the various functions of the circuit. The main transformer 202 is used to convert a standard 120 V_{AC} power input to a full wave rectified signal with significantly lower peak voltages appropriate for feeding the DC/DC converters of power supply 204. The power conditioning section is designed such that a standard input line voltage variation of 90 V_{AC} to 135 V_{AC} is acceptable and all circuitry functions as intended throughout this input voltage range. A battery 206 is provided for backup and fail-safe functions in situations when the main AC input power is lost. Cold water valve 234 and hot water valve 236 preferably are ball valves coupled to DC motors which can be electrically driven to open the valves and allow water flow, or close the valves and arrest water flow. Panel switch 208 is a mechanical switch used to provide power to a set of blue light emitting diodes (LEDs) 228 when the panel of the system is removed to provide access to the internal drain plumbing. The blue LEDs 228 provide illumination for visualizing and inspecting the internal plumbing of the system. Floor moisture sensor 210 is a device which provides a signal to indicate the presence or absence of water in the location of the sensor. Drain backup sensor 212 is a device which provides a signal to indicate the presence or absence of a blockage in the plumbing drain. Open button 214 is the first user input device which, when pressed, provides a signal used by processor 200 to start open the water valves. Close button 216 is the second user input device which, when pressed, provides a signal used by processor 200 to close the water valves. Mute button 218 is a user input device which, when pressed, provides a signal to processor 200 to mute an active audible alarm generated as a result of active signals from the floor and/or drain sensors 210 and 212, respectively. Utility sense signal 220 is a signal that indicates the presence or absence of the main AC input power. Battery monitor signal 222 indicates the voltage level of the backup battery. Cold valve current limit signal 224 indicates the point at which the cold water valve has reached the end of its mechanical travel limit, or encountered substantial mechanical resistance in the cold valve travel range. Hot valve current limit signal 226 indicates the point at which the hot water valve has reached the end of its mechanical travel limit, or encountered a substantial mechanical resistance in the hot valve travel range. The 20 amp relay 230 is a mechanical relay which is controlled by processor 200 and associated driver circuitry to apply or remove the main AC input power to the 20 amp GFCI receptacle 232. Green LED 238 is a visual indicator which is illuminated when the water valves are open, and also indirectly indicates when power is applied to GFCI receptacle 232. Green LED 238 also flashes while the system is performing an open valve function but both valves have not yet reached their fully open position. Red LED 240 is a visual indicator which is illuminated when the water valves are closed and flashes while the system is performing a close valve function but both valves have not yet reached their fully closed position. Red LED 242 is a visual indicator which is illuminated when moisture has been detected by floor moisture sensor 210. Red LED 244 is a visual indicator which is illuminated when a drain backup has been detected by drain sensor 212. Red LED 246 is a visual indicator which is illuminated when the system battery voltage has fallen below a pre-determined voltage threshold which alerts the user to replace the battery. Red LED 248 is a visual indicator which is illuminated in the event of an alarm condition triggered by active signals generated by floor moisture sensor 210 or drain backup sensor 212. Piezo buzzer 250 is an audible output device which is sounded in the event of an alarm condition triggered by active signals generated by floor moisture sensor 210 or drain backup sensor 212. The Form-C auxiliary relay 252 is provided as an external communication mechanism which changes states in the event of an alarm condition triggered by active signals generated by floor moisture sensor 210 or drain backup sensor 212. The auxiliary relay 252 may be used to trigger external systems in order to expand protection and reporting mechanisms.

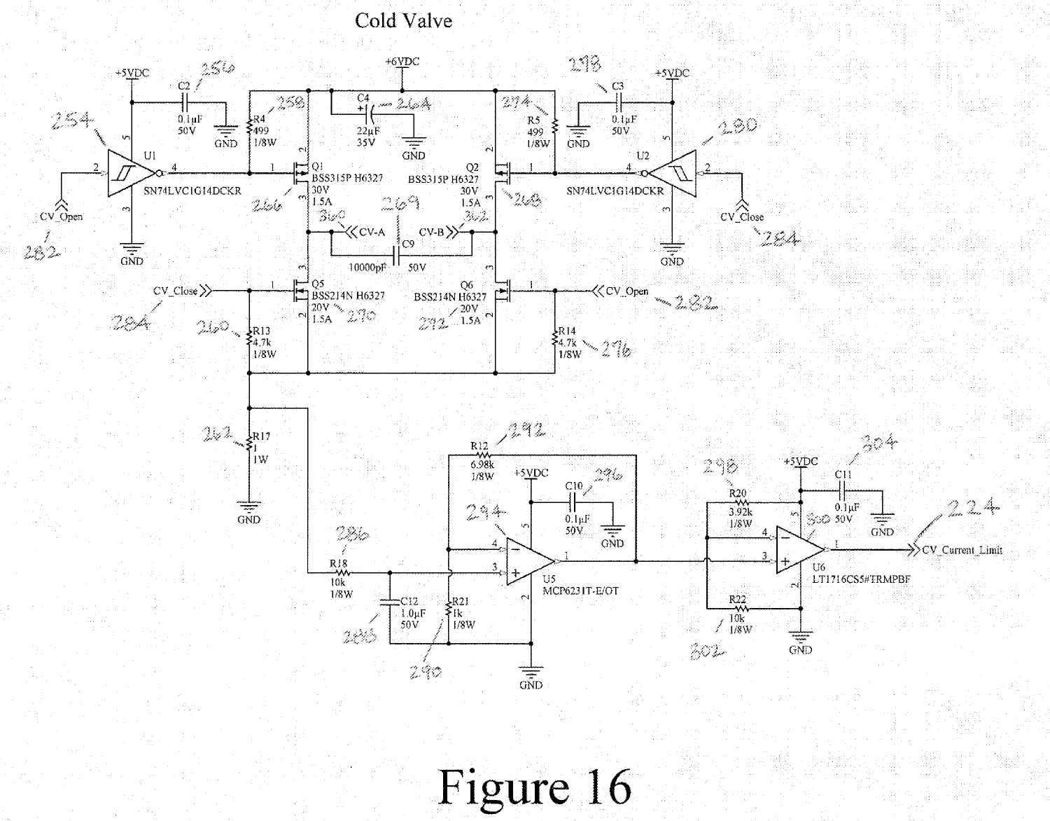

With reference to FIG. 16, an electrical circuit is shown which provides the function of driving a motorized valve for the cold water supply and generating a feedback voltage indicative of mechanical resistance encountered by the cold water valve. Key electrical components in this figure are: P-Channel MOSFETs 266 and 268 manufactured by Infineon Technologies under part number BSS315P H6327; N-Channel MOSFETs 270 and 272 manufactured by Infineon Technologies under part number BSS214N H6327; Schmitt-Trigger Inverters 254 and 280 manufactured by Texas Instruments under part number SN74LVC1G14DCKR; Operational Amplifier 294 manufactured by Microchip Technology under part number MCP6231T-E/OT; and Comparator 300 manufactured by Linear Technology under part number LT1716CS5#TRMPBF. The four MOSFETs, or electrical switches, 266, 268, 270, and 272 are configured into what is referred to as an H-Bridge. An H-Bridge is a common electrical circuit topology used to provide a voltage with a controllable polarity to a particular load. In this case, the H-Bridge, made up of switches 266, 268, 270, and 272, is used to drive a motorized cold water valve in two different directions, namely the open direction and the close direction, by selectively applying voltages of a different polarity to the valve motor. Each of the four electrical switches 266, 268, 270, and 272 pass a current between pins 2 and 3 when the appropriate gate threshold voltage is applied to pin 1. For the top P-Channel MOSFETs 266 and 268, the semiconductor channel between pins 2 and 3 will conduct electrical current when the voltage at pin 1 with respect to pin 2 is less than what is referred to as the gate threshold voltage. For the bottom N-Channel MOSFETs 270 and 272, the semiconductor channel between pins 2 and 3 will conduct electrical current when the voltage at pin 1 with respect to pin 2 is greater than the gate threshold voltage. The cold water valve motor is connected between points 360 and 362. Capacitor 269 provides high frequency AC noise filtering to dampen electrical noise generated by the valve motor. To drive the cold water valve motor to an open position, processor 200 provides a +5 VDC signal to node 282. The single signal 282 is applied to both pin 1 of switch 272 as well as the input of inverter 254. Inverter 254 simply inverts the signal applied to its input pin 2 and makes the inverted signal available at the output pin 4. In this case, since processor 200 has applied +5 VDC to the input of inverter 254, the output is pulled low to ground. In turn, pin 1 of switch 266 is pulled low and current is allowed to flow through the semiconductor channel between pins 2 and 3 of switch 266. This operation applies +6 VDC to node 360 which is ultimately connected to one lead wire of the cold water valve motor through PCB traces and an intermediate connector 358. When processor 200 applies +5 VDC to node 282, pin 1 of switch 272 will be held high also allowing current to flow through the semiconductor channel between pins 2 and 3. This operation applies ground to the remaining valve motor lead wire connected through connector 358 to node 362 causing the motor to rotate and drive the valve in the open direction. To drive the cold water valve in the opposite direction, or closed, node 282 is pulled low and node 284 is pulled high to +5 VDC by processor 200. Inverter 280 inverts the single signal applied to node 284 by processor 200 so that current flows through switch 268 at the same time current is flowing through switch 270. Resistors 258, 274, 260, and 276 are provided to keep all four switches 266, 268, 270, and 272 in the off state when the system is first powered up and before processor 200 has finished initializing and has actively taken control of the states of nodes 282 and 284. Capacitors 256 and 278 provide local filtering of the +5 VDC power supplies for each of inverters 254 and 280, respectively. Capacitor 264 provides bulk transient filtering to facilitate inrush current for the valve motor in an attempt to keep the +6 VDC supply to the valve motor from decreasing in value. Resistor 262 is used as a current sense resistor which provides a positive voltage to resistor 286 when current is flowing through the cold valve motor, no matter the polarity of the applied voltage to the valve motor from the H-Bridge. The voltage generated by current sense resistor 262 is fed to a 2-stage signal conditioning circuit in order to provide a signal back to processor 200 which is indicative of mechanical resistance applied to the cold water valve. Operational amplifier 294 is set up in a non-inverting voltage amplifier mode. The gain of this non-inverting voltage amplifier is set by resistors 290 and 292. The amplified current sense voltage is then compared to a fixed threshold voltage at the input of comparator 300. The fixed voltage threshold which is used to compare against the current sense voltage is set by resistors 298 and 302. If the voltage at pin 3 of Comparator 300 is higher than the fixed reference voltage applied to pin 4, the output at pin 1 will rise to +5 VDC. If the opposite input state is present at comparator 300, the output at pin 1 will be connected to ground. If the cold water valve encounters a strong mechanical resistance by running into a hard stop at either end of its maximum travel or hitting an obstacle in the middle of its travel range, the current through the valve motor will rise rapidly and ultimately create a high voltage on pin 3 of comparator 300. As soon as this current sense voltage rises above the fixed threshold applied to pin 4 of comparator 300, the output at pin 1 will increase to +5 VDC. The output of comparator 300 is directly delivered to processor 200 via node 224. When the processor recognizes +5 VDC is present at node 224, the algorithm immediately removes any command which has turned on the H-Bridge and in turn removes voltage that was applied to the valve motor. This process is in place so that the valve motor is not continuously driven with electrical current when its movement has been stopped by a mechanical force. This operation protects the valve motor and all of the electronic components driving the motor, from excessive stress. Resistor 286 and capacitor 288 form an R-C time constant which delays the signal coming from current sense resistor 262. A delay on the current limit voltage is provided so that higher inrush currents that the valve motor pulls from the +6 VDC supply are ignored and the motor is allowed to get up to rated speed and rated current before processor 200 would provide a nuisance shutdown command to the H-Bridge. Capacitors 296 and 304 provide local noise filtering of the +5 VDC power supply for operational amplifier 294 and comparator 300, respectively.

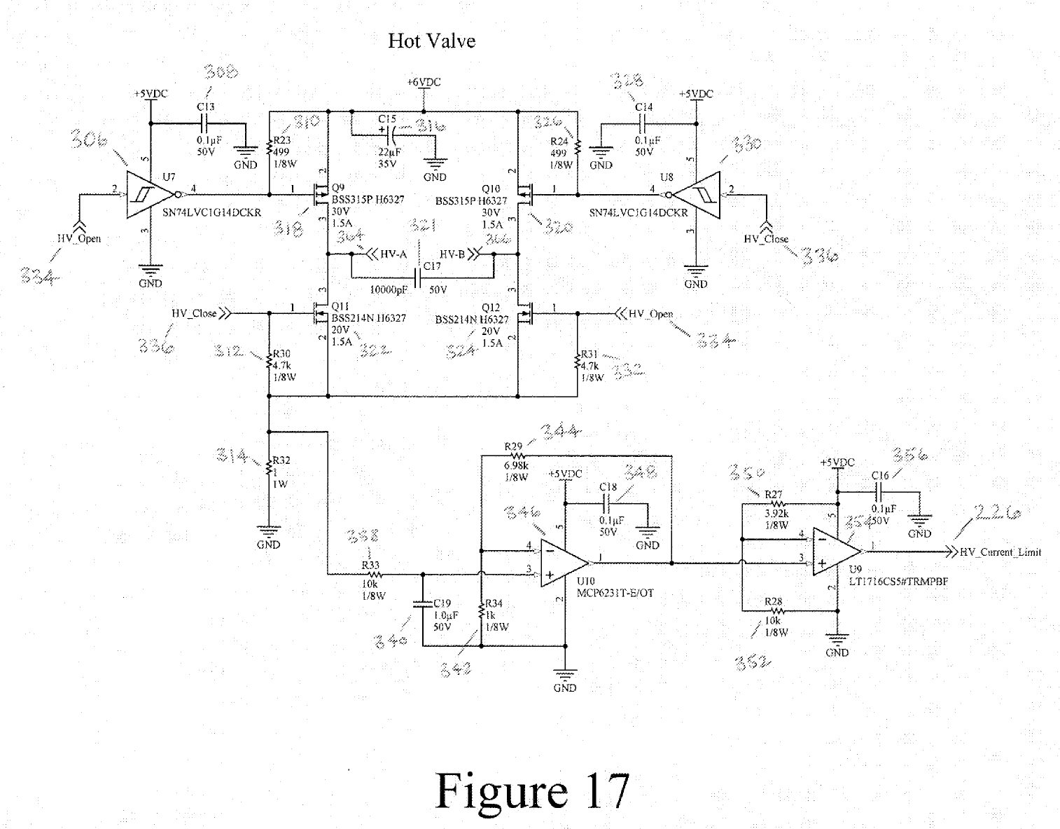

With reference to FIG. 17, an electrical circuit is shown which provides the function of driving a motorized valve for the hot water supply and generating a feedback voltage indicative of mechanical resistance encountered by the hot water valve. Key electrical components in this figure are: P-Channel MOSFETs 318 and 320 manufactured by Infineon Technologies under part number BSS315P H6327; N-Channel MOSFETs 322 and 324 manufactured by Infineon Technologies under part number BSS214N H6327; Schmitt-Trigger Inverters 306 and 330 manufactured by Texas Instruments under part number SN74LVC1G14DCKR; operational amplifier 346 manufactured by Microchip Technology under part number MCP6231T-E/OT; and comparator 354 manufactured by Linear Technology under part number LT1716CS5#TRMPBF. The four MOSFETs, or electrical switches, 318, 320, 322, and 324 are configured into what is referred to as an H-Bridge, and as described above with respect to the cold valve control circuit. An H-Bridge is a common electrical circuit topology used to provide a voltage with a controllable polarity to a particular load. In this case, the H-Bridge made up of switches 318, 320, 322, and 324 is used to drive a motorized hot water valve in two different directions, namely open and closed, by selectively applying voltages of a different polarity to the valve motor. Each of the four electrical switches 318, 320, 322, and 324 will pass a current between pins 2 and 3 when the appropriate gate threshold voltage is applied to pin 1. For the top P-Channel MOSFETs 318 and 320, the semiconductor channel between pins 2 and 3 will conduct electrical current when the voltage at pin 1 with respect to pin 2 is less than what is referred to as the gate threshold voltage. For the bottom N-Channel MOSFETs 322 and 324, the semiconductor channel between pins 2 and 3 will conduct electrical current when the voltage at pin 1 with respect to pin 2 is greater than the gate threshold voltage. The hot water valve motor is connected between nodes 364 and 366. Capacitor 321 provides high frequency AC noise filtering to dampen electrical noise generated by the valve motor. To drive the hot water valve motor to an open position, processor 200 provides a +5 VDC signal to node 334. The single signal 334 is applied to both pin 1 of switch 324 as well as the input of inverter 306. Inverter 306 simply inverts the signal applied to its input pin 2 and makes the inverted signal available at the output pin 4. In this case, since processor 200 has applied +5 VDC to the input of inverter 306, the output is pulled low to ground. In turn, pin 1 of switch 318 is pulled low and current is allowed to flow through the semiconductor channel between pins 2 and 3 of switch 318. This operation applies +6 VDC to node 364 which is ultimately connected to one lead wire of the hot water valve motor through PCB traces and an intermediate connector 358. When processor 200 applies +5 VDC to node 334, pin 1 of switch 324 will be held high also allowing current to flow through the semiconductor channel between pins 2 and 3. This operation applies ground to the remaining valve motor lead wire connected through connector 358 to node 366 causing the motor to rotate the valve in the open direction. To drive the hot water valve in the other direction, or closed, node 334 is pulled low and node 336 is pulled high to +5 VDC by processor 200. Inverter 330 inverts the single signal applied to node 336 by processor 200 so that current flows through switch 320 at the same time current is flowing through switch 322. Resistors 310, 326, 332 and 312 are provided to keep all four switches 318, 320, 322, and 324 in the off state when the system is first powered up and before processor 200 has finished initializing and has actively taken control of the states of nodes 334 and 336. Capacitors 308 and 328 provide local filtering of the +5 VDC power supplies for each of inverters 306 and 330, respectively. Capacitor 316 provides bulk transient filtering to facilitate inrush current for the valve motor in an attempt to keep the +6 VDC supply to the valve motor from decreasing in value. Resistor 314 is used as a current sense resistor which provides a positive voltage to resistor 338 when current is flowing through the hot valve motor, no matter the polarity of the applied voltage to the valve motor from the H-Bridge. The voltage generated by current sense resistor 314 is fed to a 2-stage signal conditioning circuit in order to provide a signal back to processor 200 which is indicative of mechanical resistance applied to the hot water valve. Operational amplifier 346 is set up in a non-inverting voltage amplifier mode. The gain of this non-inverting voltage amplifier is set by resistors 342 and 344. The amplified current sense voltage is then compared to a fixed threshold voltage at the input of comparator 354. The fixed voltage threshold which is used to compare against the current sense voltage is set by resistors 350 and 352. If the voltage at pin 3 of comparator 354 is higher than the fixed reference voltage applied to pin 4, the output at pin 1 will rise to +5 VDC. If the opposite input state is present at comparator 354, the output at pin 1 will be connected to ground. If the hot water valve encounters a strong mechanical resistance by running into a hard stop at either the end of its maximum travel or by hitting an obstacle in the middle of its travel range, the current through the valve motor will rise rapidly and ultimately create a high voltage on pin 3 of comparator 354. As soon as this current sense voltage rises above the fixed threshold applied to pin 4 of comparator 354, the output at pin 1 will increase to +5 VDC. The output of comparator 354 is directly delivered to processor 200 via node 226. When the processor recognizes +5 VDC is present at node 226, the algorithm immediately removes any command which has turned on the H-Bridge and in turn removes voltage that was applied to the valve motor. This process is in place so that the valve motor is not continuously driven with electrical current when its movement has been stopped by a mechanical force. This operation protects the valve motor and all of the electronic components driving the motor from excessive stress. Resistor 338 and capacitor 340 form an R-C time constant which delays the signal coming from current sense resistor 314. A delay on the current limit voltage is provided so that higher inrush currents that the valve motor pulls from the +6 VDC supply are ignored and the motor is allowed to get up to rated speed and rated current before processor 200 would provide a nuisance shutdown command to the H-Bridge. Capacitors 348 and 356 provide local noise filtering of the +5 VDC power supply for operational amplifier 346 and comparator 354, respectively.

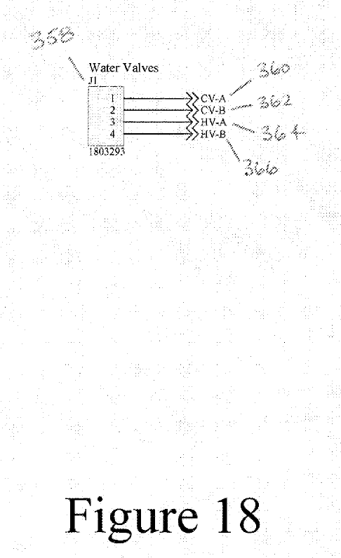

With reference to FIG. 18, an electrical circuit is shown which provides the function of physically connecting each of the two water valves in the system to the PCB. Connector 358, manufactured by Phoenix Contact under part number 1803293, connects nodes 360, 362, 364, and 366 from the valve motor driver H-Bridges are wired to pins 1 through 4 of connector 358 and which provides a convenient method for connecting the valve motor wire leads to the PCB.

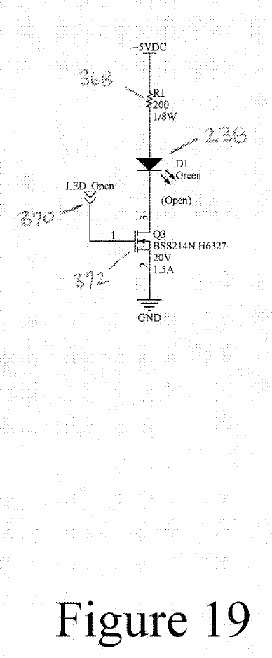

With reference to FIG. 19, an electrical circuit is shown which provides the function of illuminating a green LED. LED 238, manufactured by Osram Opto Semiconductors Inc. under part number LF T671-L2N1-1-Z, and N-Channel MOSFET 372 manufactured by Infineon Technologies under part number BSS214N H6327 turn on lighting LED 238 that, when illuminated, provides information indicate that the water valves are fully open and the GFCI receptacle is powered on. A flashing LED 238 indicates that the system is driving the water valves to the open position but the valves have not yet reached the end of their mechanical travel. Node 370 represents a signal generated by processor 200. When green LED 238 should be illuminated, processor 200 asserts node 370 high to +5 VDC which turns on electrical switch 372 and allows current to flow through its channel between pins 3 and 2. When current is flowing through the series combination of resistor 368, LED 238, and MOSFET 372, the LED will be illuminated. Resistor 368 is sized to drop excess voltage from the +5 VDC power supply so that the appropriate LED current is generated.

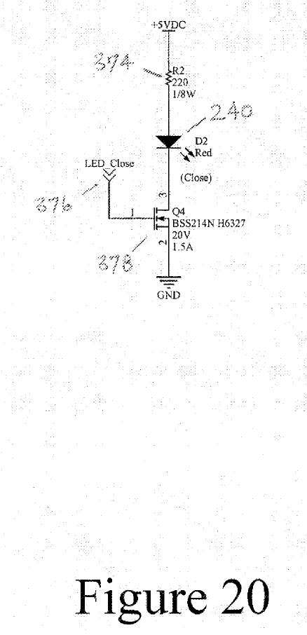

With reference to FIG. 20, an electrical circuit is shown which provides the function of illuminating a red LED. LED 240, manufactured by Osram Opto Semiconductors Inc. under part number LH T674-M2P1-1-Z, and N-Channel MOSFET 378, manufactured by Infineon Technologies under part number BSS214N H6327, when on, indicates when the water valves are fully closed and the GFCI receptacle is powered off. A flashing LED 240 indicates that the system is driving the water valves to the closed position but the valves have not yet reached the end of their mechanical travel. Node 376 represents a signal generated by processor 200. When red LED 240 should be illuminated, processor 200 asserts node 376 high to +5 VDC which turns on electrical switch 378 and allows current to flow through its channel between pins 3 and 2. When current is flowing through the series combination of resistor 374, LED 240, and MOSFET 378, the LED will be illuminated. Resistor 374 is sized to drop excess voltage from the +5 VDC power supply so that the appropriate LED current is generated.

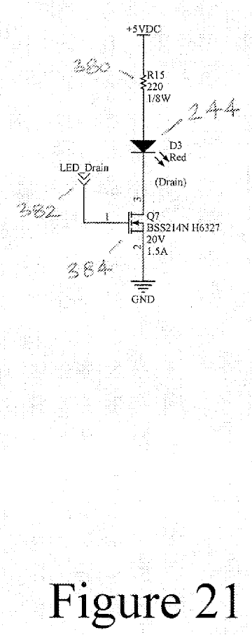

With reference to FIG. 21, an electrical circuit is shown which provides the function of illuminating a red LED. When illuminated, LED 244, manufactured by Osram Opto Semiconductors Inc. under part number LH T674-M2P1-1-Z, and N-Channel MOSFET 384 manufactured by Infineon Technologies under part number BSS214N H6327 indicate when the drain sensor has detected a drain backup event by detecting liquid. Node 382 represents a signal generated by processor 200. When red LED 244 should be illuminated, processor 200 asserts node 382 high to +5 VDC which turns on electrical switch 384 and allows current to flow through its channel between pins 3 and 2. When current is flowing through the series combination of resistor 380, LED 244, and MOSFET 384, the LED will be illuminated. Resistor 380 is sized to drop excess voltage from the +5 VDC power supply so that the appropriate LED current is generated.

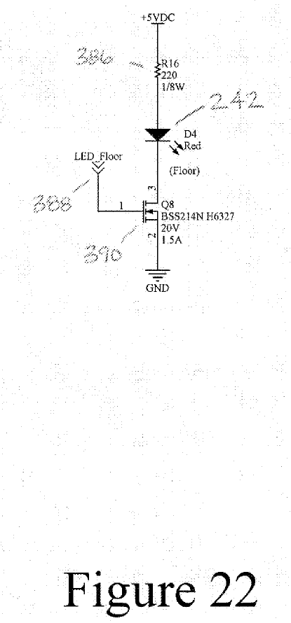

With reference to FIG. 22, an electrical circuit is shown which provides the function of illuminating a red LED. When energized, LED 242, manufactured by Osram Opto Semiconductors Inc. under part number LH T674-M2P1-1-Z and N-Channel MOSFET 390, manufactured by Infineon Technologies under part number BSS214N H6327, indicate when the floor moisture sensor has detected the presence of water in the area of the sensor. Node 388 represents a signal generated by processor 200. When red LED 242 should be illuminated, processor 200 asserts node 388 high to +5 VDC which turns on electrical switch 390 and allows current to flow through its channel between pins 3 and 2. When current is flowing through the series combination of resistor 386, LED 242, and MOSFET 390, the LED will be illuminated. Resistor 386 is sized to drop excess voltage from the +5 VDC power supply so that the appropriate LED current is generated.

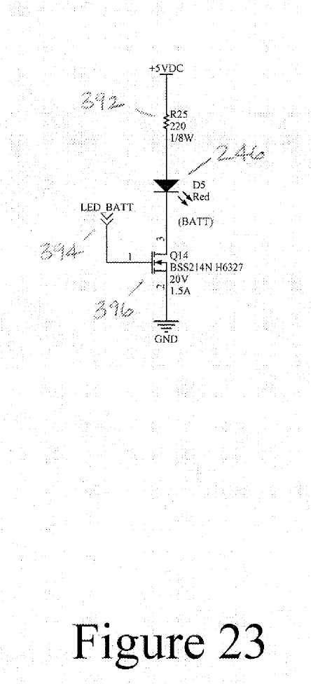

With reference to FIG. 23, an electrical circuit is shown which provides the function of illuminating a red LED. When energized, LED 246, manufactured by Osram Opto Semiconductors Inc. under part number LH T674-M2P1-1-Z, and N-Channel MOSFET 396, manufactured by Infineon Technologies under part number BSS214N H6327, indicates when the battery voltage has fallen below a first threshold or first predetermined voltage. The first low battery threshold indicates that the battery is nearing end of life and the user should replace the battery soon. A flashing LED 246 indicates that the battery voltage has fallen below a second threshold or second predetermined voltage, which is a critical level. When the battery voltage has fallen below the second threshold, the possibility exists that there is no longer enough battery power present to perform all fail-safe functions in the event of a 120 VAC main power outage. Alternatively, LED 246 will signal that the backup battery has not been installed, thus calling attention to this fact so that the system is not operated without the appropriate fail safe mechanisms intact. Node 394 represents a signal generated by processor 200. When red LED 246 should be illuminated, processor 200 asserts node 394 high to +5 VDC which turns on electrical switch 396 and allows current to flow through its channel between pins 3 and 2. When current is flowing through the series combination of resistor 392, LED 246, and MOSFET 396, the LED will be illuminated. Resistor 392 is sized to drop excess voltage from the +5 VDC power supply so that the appropriate LED current is generated.

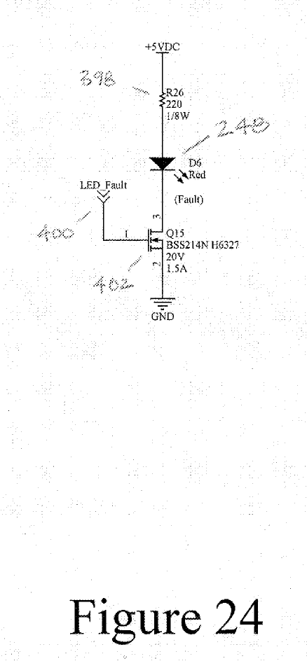

With reference to FIG. 24, an electrical circuit is shown which provides the function of illuminating a red LED. When energized, LED 248, manufactured by Osram Opto Semiconductors Inc. under part number LH T674-M2P1-1-Z, and N-Channel MOSFET 402, manufactured by Infineon Technologies under part number BSS214N H6327, indicated a fault status, i.e., that while the system was trying to drive the water valve either closed or open. In normal operation, a current spike from each of the valve motors will be measured within some specified time after processor 200 delivers a signal to start motor movement. If this motor current spike is not measured within 5 seconds after the movement command is generated by processor 200, the system goes into fault mode and illuminates LED 248. A fault status could indicate that a defective valve has been connected to the system, or that one or both water valves are disconnected electrically. Node 400 represents a signal generated by processor 200. When red LED 248 should be illuminated, processor 200 asserts node 400 high to +5 VDC which turns on electrical switch 402 and allows current to flow through its channel between pins 3 and 2. When current is flowing through the series combination of resistor 398, LED 248, and MOSFET 402, the LED will be illuminated. Resistor 398 is sized to drop excess voltage from the +5 VDC power supply so that the appropriate LED current is generated.

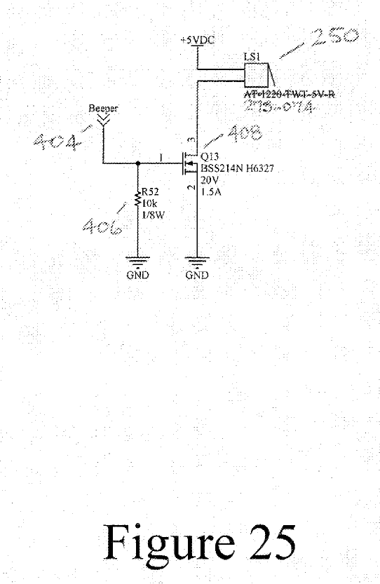

With reference to FIG. 25, an electrical circuit is shown which provides the function of sounding a piezo buzzer, also referred to as a beeper. When energized, piezo buzzer 250, manufactured by Radio Shack under part number 273-074, and N-Channel MOSFET 408, manufactured by Infineon Technologies under part number BSS214N H6327, indicates that a fault has been detected by either the drain sensor 212 or floor sensor 210. When beeper 250 should be sounded, processor 200 asserts node 404 high to +5 VDC which turns on electrical switch 408 and allows current to flow through its channel between pins 3 and 2. When current is flowing through the series combination of beeper 250 and MOSFET 408, the beeper will be sounded. Resistor 406 is provided to pull pin 1 of electrical switch 408 low which ensures the beeper will not be sounded until the moment processor 200 generates a driving command.

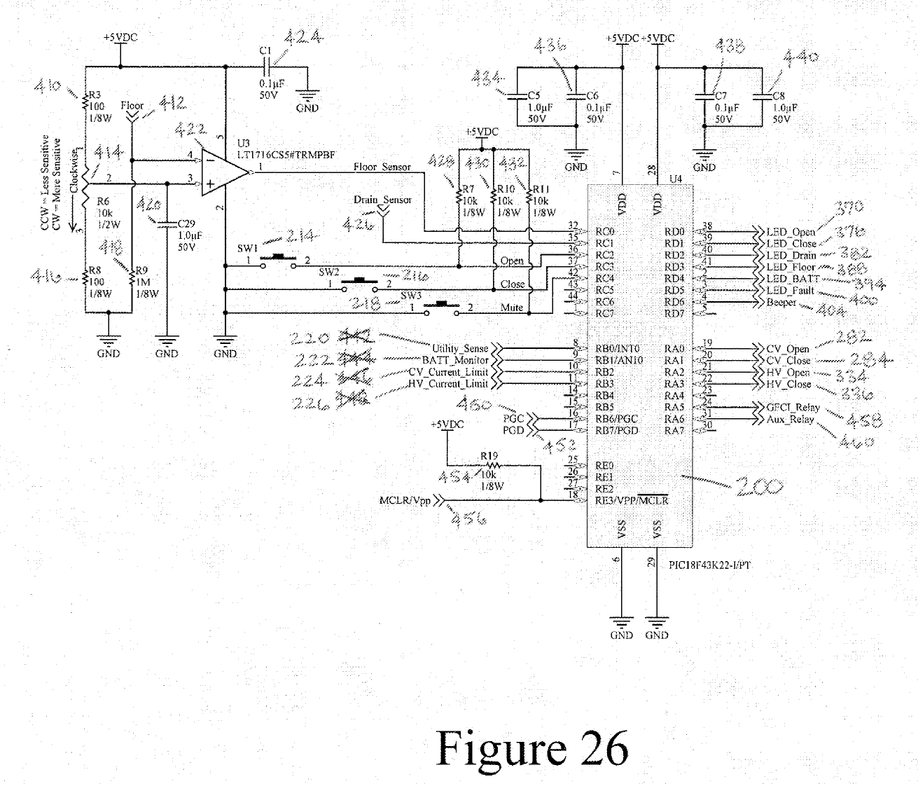

With reference to FIG. 26, an electrical circuit is shown which depicts input and output mapping for processor 200 and which conditions the floor sensor 210 signal. The preferred electrical components are processor 200, manufactured by Microchip Technology under part number PIC18F43K22-I/PT, potentiometer 414 manufactured by Bourns Inc., under part number 33615-1-103GLF, comparator 422 manufactured by Linear Technology under part number LT1716CS5#TRMPBF and switches 214, 216, and 218 manufactured by E-Switch under part number TL3301AF160QG. Node 412 emanates from a connector which brings in a signal from a conventional floor sensor 210 that is placed on the floor or other surface near the bottom of the washing machine. When exposed to water, floor sensor 210 develops a resistance between node 412 and the +5 VDC power supply. With this resistance present, current now flows from the +5 VDC power supply through the resistance of the water exposed to sensor 210 and through resistor 418 to ground. This process develops a voltage which is then applied to pin 4 of comparator 422. The voltage on pin 4 of comparator 422 is compared to an adjustable voltage threshold on pin 3 by the series combination of resistors 410 and 416 and potentiometer 414. Potentiometer 414 provides a sensitivity adjustment so that the user can tune the system to the environment in which it is installed. When the voltage generated on pin 4 of comparator 422 is higher than the adjustable voltage threshold present on pin 3, the output at pin 1 is driven low to ground. The system is configured such that a low or ground signal at pin 1 of comparator 422 represents water present in the area of floor sensor 210. In other words, the floor sensor signal is active low. The signal generated on pin 1 of comparator 422, indicative of the presence or absence of water detected by floor sensor 210, is presented as an input on pin 32 of processor 200. Capacitor 424 provides local +5 VDC power supply noise filtering for comparator 422. Capacitor 420 provides filtering for the adjustable voltage threshold presented to pin 3 of comparator 422 so as to maintain a stable voltage reference. Node 426 is a signal emanating from the drain sensor which is indicative of the presence or absence of a drain backup event, i.e., water in the drain. The drain sensor signal on node 426 is active low, meaning that a low state indicates the presence of a drain backup and a high +5 VDC state indicates a normal non-alarm state. The active low drain sensor signal is presented as an input on pin 35 of processor 200. Switch 214 provides an input representing an open valve command to pin 36 of processor 200. Resistor 428 pulls pin 36 high to +5 VDC when switch 214 is not asserted. When switch 214 is asserted, the input on pin 36 of processor 200 is pulled low indicating a command for the system to begin an open valve sequence. Switch 216 provides an input representing a close valve command to pin 37 of processor 200. Resistor 430 pulls pin 37 high to +5 VDC when switch 216 is not asserted. When switch 216 is asserted, the input on pin 37 of processor 200 is pulled low indicating a command for the system to begin a close valve sequence. Switch 218 provides an input representing an alarm mute command to pin 42 of processor 200. Resistor 432 pulls pin 42 high to +5 VDC when switch 218 is not asserted. When switch 218 is asserted, the input on pin 42 of processor 200 is pulled low indicating a command for the system to stop sounding beeper 250. Node 220 is an active high input to pin 8 of processor 200 indicative of the presence or absence of the main 120 VAC input power. Node 222 is an analog input to pin 9 of processor 200 indicative of the voltage state of battery 206. Node 224 is an active high input to pin 10 of processor 200 indicative of the cold water valve encountering a large mechanical resistance. Node 226 is an active high input to pin 11 of processor 200 indicative of the hot water valve encountering a large mechanical resistance. Node 450 is a clock signal used for programming processor 200. Node 452 is a data signal used for programming processor 200. Node 456 is the master clear signal used for placing processor 200 in program mode or run mode. Resistor 454 is used to pull the master clear line on processor 200 high which is required for normal run mode. Node 370 is an active high output at pin 38 of processor 200, used to drive circuitry for illuminating open LED 238. Node 376 is an active high output at pin 39 of processor 200, used to drive circuitry for illuminating close LED 240. Node 382 is an active high output at pin 40 of processor 200, used to drive circuitry for illuminating drain LED 244. Node 388 is an active high output at pin 41 of processor 200, used to drive circuitry for illuminating floor LED 242. Node 394 is an active high output at pin 2 of processor 200, used to drive circuitry for illuminating battery LED 246. Node 400 is an active high output at pin 3 of processor 200, used to drive circuitry for illuminating fault LED 248. Node 404 is an active high output at pin 4 of processor 200, used to drive circuitry for sounding beeper 250. Node 282 is an active high output at pin 19 of processor 200, used to command the cold water valve H-Bridge to open the cold water valve. Node 284 is an active high output at pin 20 of processor 200, used to command the cold water valve H-Bridge to close the cold water valve. Node 334 is an active high output at pin 21 of processor 200, used to command the hot water valve H-Bridge to open the hot water valve. Node 336 is an active high output at pin 22 of processor 200, used to command the hot water valve H-Bridge to close the hot water valve. Node 458 is an active high output at pin 24 of processor 200, used to drive GFCI relay 230 so it provides main 120 VAC power to GFCI receptacle 232. Node 460 is an active high output at pin 31 of processor 200, used to drive auxiliary relay 252. Capacitors 434, 436, 438, and 440 all provide local +5 VDC power supply filter for processor 200.

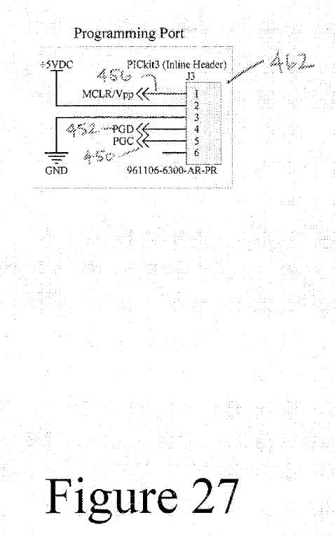

With reference to FIG. 27, an electrical circuit is shown which depicts a programming connection to processor 200. Connector 462 manufactured by 3M under part number 961106-6300-AR-PR. Connector 462 is most preferred because it interfaces well with the PICkit3 programming interface manufactured by Microchip Technology, although other programming methods are available and may be used. Node 456 (the master clear line), node 452 (the programming data line), and node 450 (the programming clock line), along with the +5 VDC power supply and ground connections are all required for proper programming of processor 200.

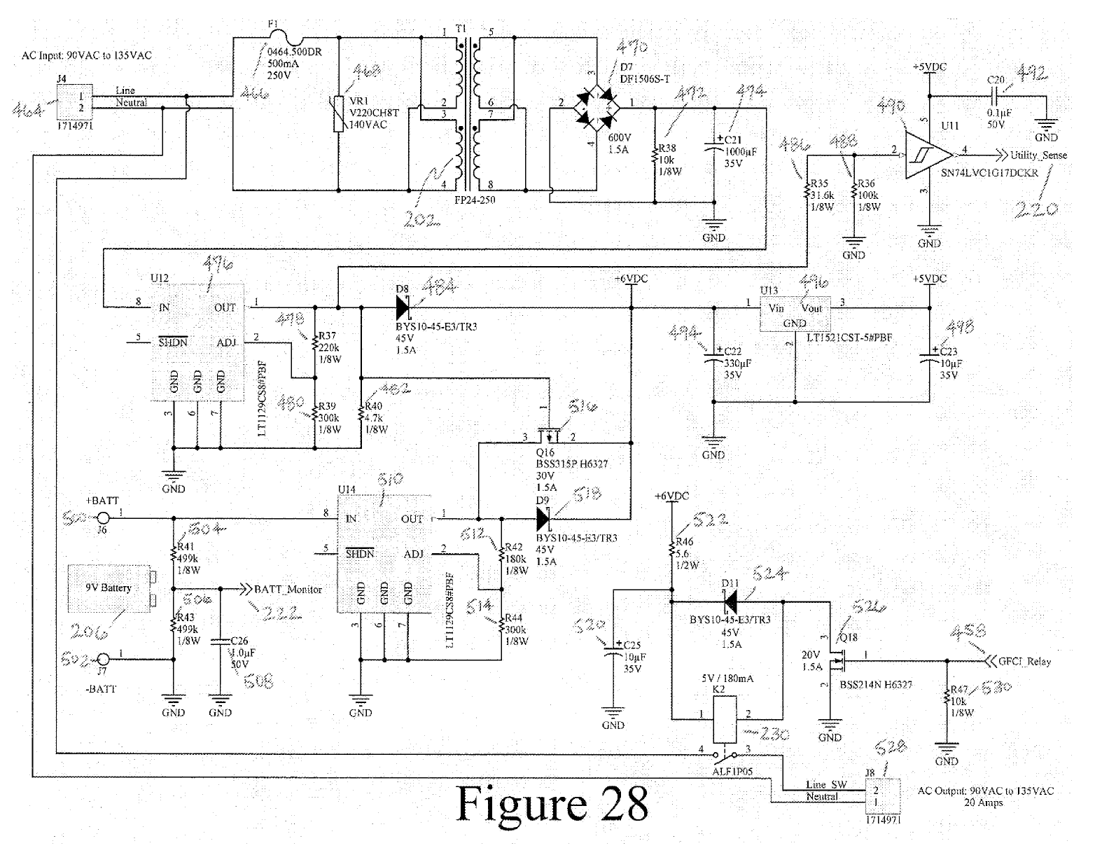

With reference to FIG. 28, an electrical circuit is shown which depicts the preferred, complete power supply section for the system, along with driver circuitry for the GFCI power relay and signal conditioning circuitry for the utility sense signal. Electrical components shown in this figure include main input connector 464 manufactured by Phoenix Contact under part number 1714971, fuse 466 manufactured by Littelfuse Inc. under part number 0464.500DR, varistor 468 manufactured by Littelfuse Inc. under part number V220CH8T, main transformer 202 manufactured by Triad Magnetics under part number FP24-250, diode bridge 470 manufactured by Diodes Inc. under part number DF1506S-T, Schmitt trigger buffer 490 manufactured by Texas Instruments under part number SN74LVC1G17DCKR, adjustable low drop out voltage regulators 476 and 510 manufactured by Linear Technology under part number LT1129CS8#PBF, Schottky diodes 484, 518, and 524 manufactured by Vishay Semiconductor Diodes Division under part number BYS 10-45-E3/TR3, P-Channel MOSFET 516 manufactured by Infineon Technologies under part number BSS315P H6327, fixed low drop out voltage regulator 496 manufactured by Linear Technology under part number LT1521CST-5#PBF, power relay 230 manufactured by Panasonic Electric Works under part number ALF1P05, N-Channel MOSFET 526 manufactured by Infineon Technologies under part number BSS214N H6327 and AC output connector 528 manufactured by Phoenix Contact under part number 1714971. Main 120 VAC input power is connected to connector 464 and is applied to main transformer 202 which steps down the peak voltages. Fuse 466 provides protection by opening up in the event of malfunction and starts to draw excess current from the main AC power line. Varistor 468 is a device which shunts voltage to ground when its threshold is exceeded. In the event of a high voltage transient on the main AC input power line, varistor 468 will clamp the excess voltage so that the components downstream are not affected. Diode bridge 470 rectifies the sinusoidal input voltage into a full wave rectified wave which is smoothed into a DC voltage with a small ripple by capacitor 474. Resistor 472 is a bleeder resistor provided to drain the charge from capacitor 474 when the main AC input power is removed from the circuit. Voltage regulator 476 converts the DC voltage generated from the main AC input into a very stable 6.5 VDC power supply as long as the input DC voltage on pin 8 is always 7.0 VDC or above. Transformer 202 is sized to ensure proper voltage is available at the input of voltage regulator 476 over an AC input voltage range of 90 VAC to 135 VAC. Resistors 478 and 480 set the output voltage of regulator 476. The voltage on pin 1 of voltage regulator 476 will be present when the main AC input power is present, and will fall to zero when the AC input power is removed so this voltage is tied to buffer 490 to be used for a utility sense signal delivered to processor 200. Capacitor 492 provides local +5 VDC power supply filtering for buffer 490. The 6.5 VDC level generated at pin 1 of regulator 476 is divided down by resistors 486 and 488 and buffered by buffer 490 so that the utility sense signal at node 220 never exceeds +5 VDC and damages processor 200. A standard 9V battery 206 is connected to plated through-holes 500 and 502 on the PCB and the battery voltage is applied to the input of voltage regulator 510. The output voltage of regulator 510 is set by resistors 512 and 514 and is designed to be 6.25 VDC, slightly lower than that delivered by regulator 476. Each voltage output of regulators 476 and 510 are configured with diodes 484 and 518 in the circuit so that one or the other regulator, but not both regulators will supply power at any one time. Also, this circuit is configures so that whenever there is “competition” between the regulators, regulator 476 will always win. Because there is a 0.5V drop across diodes 484 and 518, the node labeled +6 VDC will measure 6.0 VDC when regulator 476 is supplying power and 5.75 VDC when regulator 510 is supplying power. The +6 VDC power supply is used to drive the water valve motors. Because diodes are blocking devices, when regulator 476 is supplying voltage to the circuit, the +6 VDC power supply will not be imposed on pin 1 of regulator 510. In this diode configuration or situation, the highest voltage supplied wins and is the voltage that is delivered to the circuit. In this system, it is desired that the battery only provides backup functions and does not actively power the circuit while the main AC input power is present. For this reason, the voltage output of regulator 510 is preferably set to be 0.25 VDC lower than that of regulator 476 so that the main regulator 476 always wins and provides power to the circuit. When the main AC power is lost and regulator 476 is no longer providing an output voltage, the only voltage available in the system now comes from the battery regulator 510. P-Channel MOSFET 516 is provided to short out diode 518 at the moment the voltage output from main regulator 476 falls to zero. Shorting out diode 518 when the battery is supplying power to the circuit eliminates the 0.5 VDC drop associated with diode 518 and keeps the system alive longer as the voltage on the battery drops over time with extended use. Resistors 504 and 506 divide the 9V battery voltage down to a level safe for processor 200, which is then measured by the processor to determine the health of the backup battery. Capacitor 508 provides noise filtering for representative battery voltage delivered to processor 200 via node 222. In addition to the +6 VDC power supply required to drive the valve motors, a +5 VDC power supply is required for processor 200. The +5 VDC power supply is generated by fixed voltage regulator 496. Capacitors 494 and 498 are required for stabilization of voltage regulator 496. Power relay 230 is used to connect the main input AC power to connector 528 when the algorithm determines it is safe to do so. MOSFET 526 receives a high signal on node 458 from processor 200 which connects one side of the relay coil 230 to ground. The other side of relay coil 230 permanently connected to +6 VDC through resistor 522 which sets up the appropriate coil current when electrical switch 526 is on. The coil of relay 230 is an inductive device which generates a back EMF voltage with a sudden change in current through the relay, so diode 524 is provided to shunt this voltage to reduce noise in the circuit or damage to other components. Resistor 530 holds switch 526 in the off position until commanded to turn on by processor 200 via node 458.

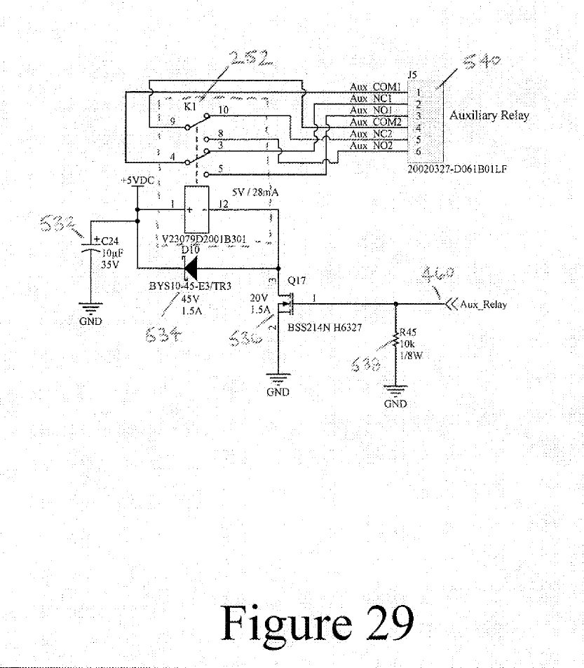

With reference to FIG. 29, an electrical circuit is shown which depicts the driver circuitry for auxiliary relay 252. The circuit components include auxiliary relay 252, manufactured by TE Connectivity under part number V23079D2001B301, connector 450 manufactured by FCI under part number 20020327-D061B01LF, Schottky diode 534 manufactured by Vishay Semiconductor Diodes Division under part number BYS 10-45-E3/TR3, and N-Channel MOSFET 536 manufactured by Infineon Technologies under part number BSS214N H6327. In the event of any alarm condition in the system, processor 200 asserts node 460 high which turns on electrical switch 536 and allows current to flow through the coil of relay 534. When current flows through the coil of relay 534 the state of the contacts presented to connector 540 is changed, and this change causes the system to provide indicators to any auxiliary equipment connected. Resistor 538 is provided to keep switch 536 off until commanded to be on by processor 200 via node 460. Capacitor 532 provides surge current capability for relay 534.

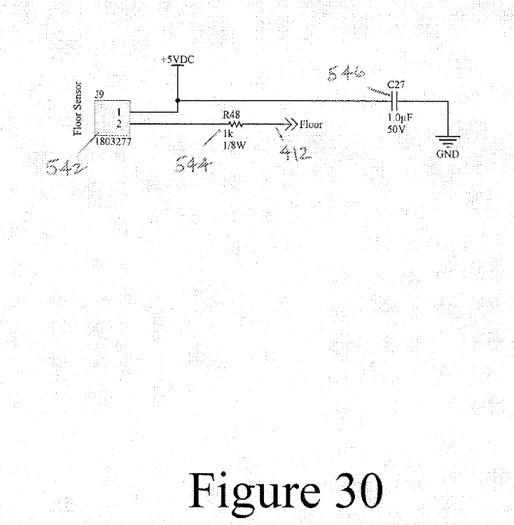

With reference to FIG. 30, an electrical circuit is provided which shows a floor moisture sensor connection to the PCB. The preferred connector 542 is manufactured by Phoenix Contact under part number 1803277. During operation, +5 VDC is provided to the floor sensor via pin 1 of connector 542, and a signal from the floor sensor is returned via pin 2 of connector 542. Resistor 544 provides ESD protection and the floor sensor signal is connected to the input of processor 200 via node 412.

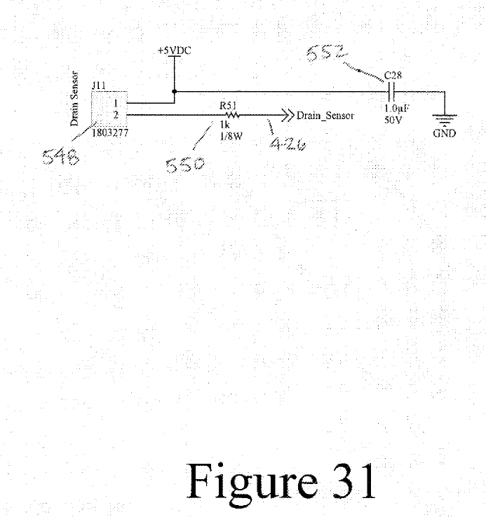

With reference to FIG. 31, an electrical circuit is provided which shows a drain sensor connection to the PCB. The preferred connector 548 is manufactured by Phoenix Contact under part number 1803277. During operation, +5 VDC is provided to the drain sensor via pin 1 of connector 548, and a signal from the drain sensor is returned via pin 2 of connector 548. Resistor 550 provides ESD protection and the floor sensor signal is connected to the input of processor 200 via node 426.

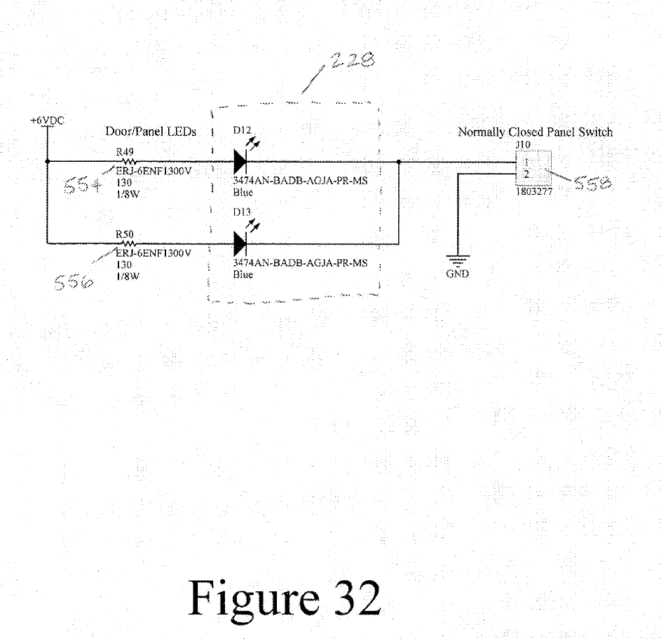

With reference to FIG. 32, an electrical circuit is shown which depicts a pair of blue LEDs connected to an external, normally closed switch. Electrical components include blue LEDs 228 manufactured by Everlight Electronics Co. Ltd., under part number 3474AN-BADB-AGJA-PR-MS and connector 558 manufactured by Phoenix Contact under part number 1803277. Preferably positioned below or behind one of the cover panels in the system, a normally closed switch is placed and which is actuated by the panel and remains open during normal operation. As the panel is removed, the switch returns to its normally closed state and connects blue LEDs 228 to ground and allows current to flow and illuminate them. Resistor 554 and 556 drop excess voltage from the +6 VDC power supply in order to set up proper current through each of the LEDs.

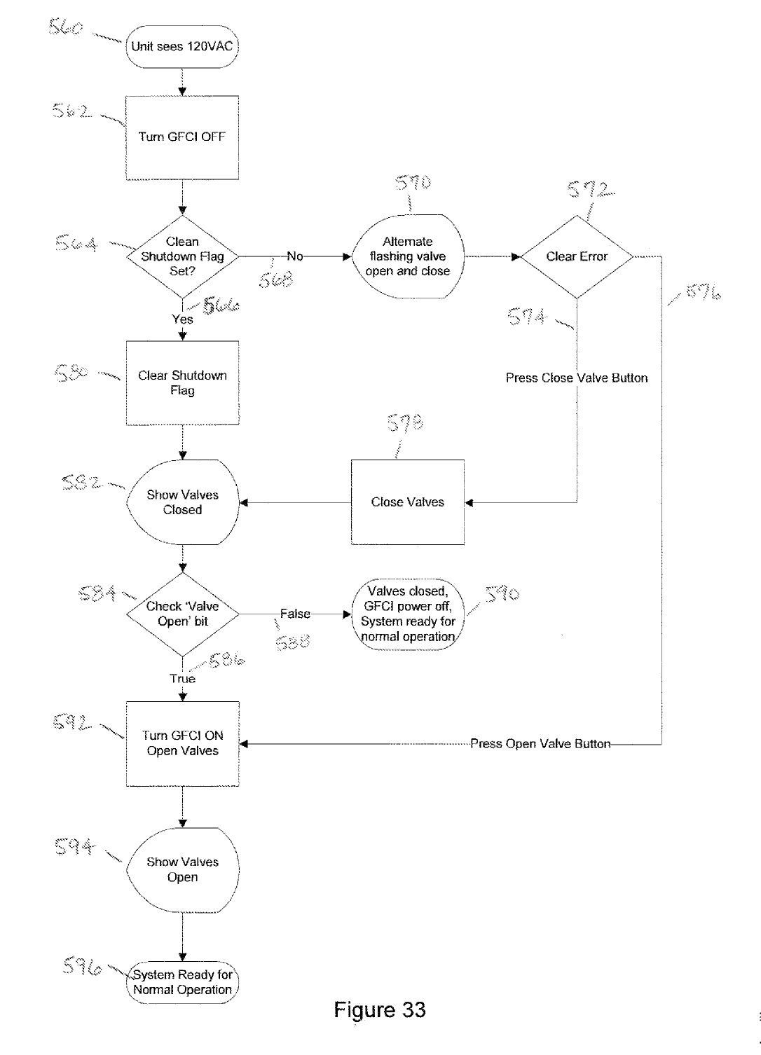

With reference to FIG. 33, a flow chart is shown for a preferred startup algorithm for the system. The start of this process is represented by starting block 560 with is the moment when 120 VAC main input power is applied. The first operation in the algorithm is to make sure the GFCI relay is off as shown in process block 562 so the GFCI receptacle remains unpowered until the system can determine what state it should go to. The clean shutdown flag referred to in decision block 564 is a flag that is set in code and which indicates that the algorithm performed all of the programmed steps for a clean shutdown the last time 120 VAC main power was lost. If the clean shutdown flag was set, the process continues along path 566 and immediately clears the shutdown flag as shown in process block 580. The display is then updated in block 582 to briefly indicate that the valves are both closed. If the clean shutdown flag has not been set when the algorithm checks its status in block 564, the process would continue along path 568 and the display would be updated to alternate flashing the open and close LEDs. When the display is flashing the open and close LEDs in an alternate fashion, this indicates to the user that the algorithm does not know what state the valves are in, therefore some sort of investigation and/or re-synchronization operation must take place in order to identify and remedy the situation so that the start-up operation can proceed. Possible causes which would result in the clean shutdown flag not being set are missing or defective water valves and a missing or dead 9V battery. Block 572 in the process is a decision point where the user has recognized the system does not know the state of the valves, so the open button or the close button must be pressed before the algorithm returns to a known state. If the close button is pressed, the process continues along path 574 and the algorithm drives both valves to the closed position. Once it is confirmed the valves are closed, the algorithm updates the display to indicate the valves are closed. Continuing to block 584, the algorithm is looking for a bit set in the code which indicates that the valves were open prior to the last event when 120 VAC was lost or intentionally removed. If the valves were not open prior to the last main power loss event, the process continues along path 588 where the loop ends because the valves are already closed and the power to the GFCI receptacle is already off as shown in block 590. If the valves were open at the time of the last main power loss event, the code would have set the valve open bit and while at block 584 the process would continue along path 586 in which the algorithm would perform the process shown in block 592 of opening both water valves and applying power to the GFCI receptacle in the system. The other way to get to process block 592 is through path 576 if the user had pressed the open valve button when performing the synchronization routine at decision point 572. Once the algorithm verifies that both water valves did open, the display is updated to indicate the valves are open as shown in block 594. At this point, the algorithm knows exactly what state the system is in and is now ready for normal operation as shown in block 596.

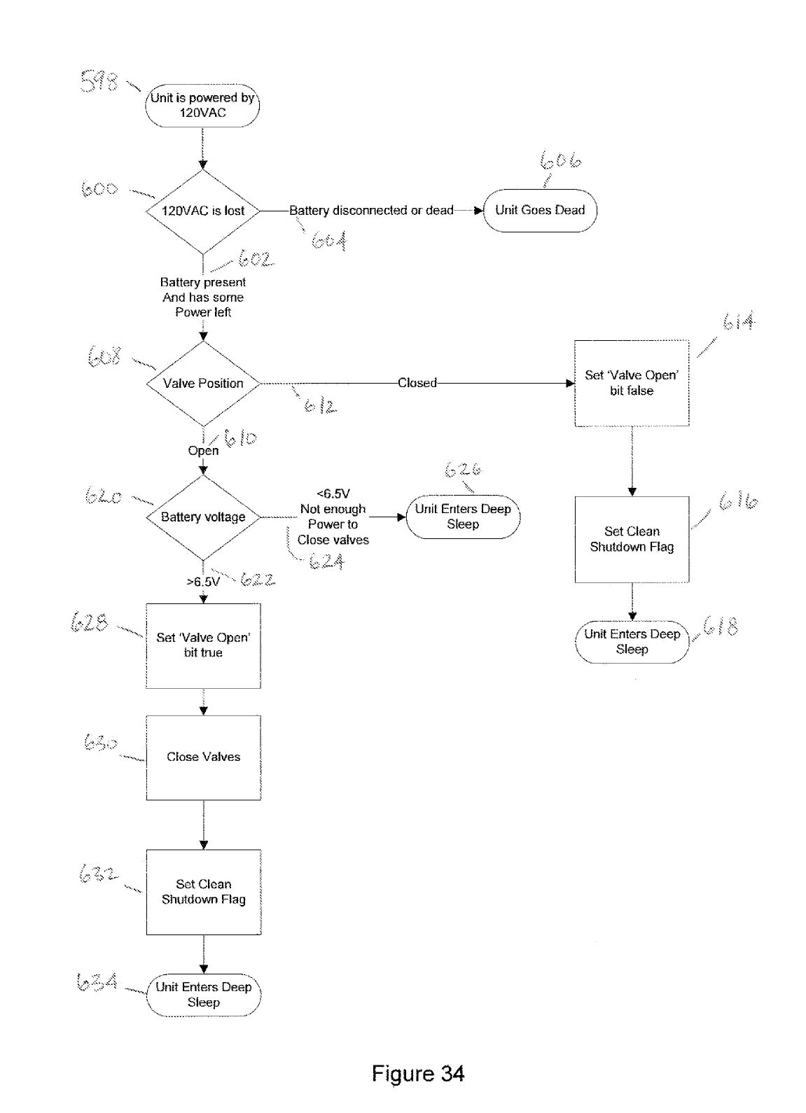

With reference to FIG. 34, a flow chart is shown for shutdown of the system. After the system is running as a result of being powered by the main 120 VAC input shown in block 598, a sequence of events takes place upon losing this power so that the system is fail safe. At decision point 600, when 120 VAC is lost and the battery is dead or missing, the system will continue along path 604 simply shutting off without performing the clean shutdown routine. If a healthy 9V battery is present the algorithm will continue along path 602 and then take one of two paths when block 608 determines whether the valves are open or closed. If the valves are closed at the moment of a 120 VAC power loss, the algorithm will continue along path 612 setting the valve open bit to false in block 614, then set the clean shutdown flag in block 616, and finally entering deep sleep in block 618 so that the current drain on the battery is minimal. The system will remain in deep sleep until 120 VAC power is restored and the utility sense signal interrupts the deep sleep mode on processor 200. If the valves are open at the moment of a 120 VAC power loss, the algorithm continues along path 610 and then looks at the level of the battery voltage. If the 9V battery voltage is below 6.5V, the algorithm will continue along path 624 and simply enter deep sleep as depicted in 626 because there is not enough power in the battery to close the valves. If the battery voltage is greater than 6.5V, continuing along path 622, the valve open bit is set to true in process block 628 followed by closing the valves in 630, shutting the clean shutdown flag in 632 and going into deep sleep mode in 634. In the preceding shutdown algorithm, an attempt is always made to close the water valves when 120 VAC power is lost. Closing the valves during a power outage puts the system into the safest state because active monitoring of the drain and floor sensors has halted. Two different parameters are used so that the system can be returned to its prior state before 120 VAC main power was lost, namely the valve open bit and the clean shutdown flag. In the scenarios described in the shutdown algorithm when the valves are driven closed following a 120 VAC power outage, the algorithm must verify that the valves were actually driven all the way closed and the valve open bit was set to false prior to setting the clean shutdown flag. This information is used when power is restored so the algorithm can return the system to a normal known state. If, for example, the valves were faulty or missing, the algorithm would not set the clean shutdown flag so at power up the display would indicate that a re-synchronization operation is required before a known state is obtained.

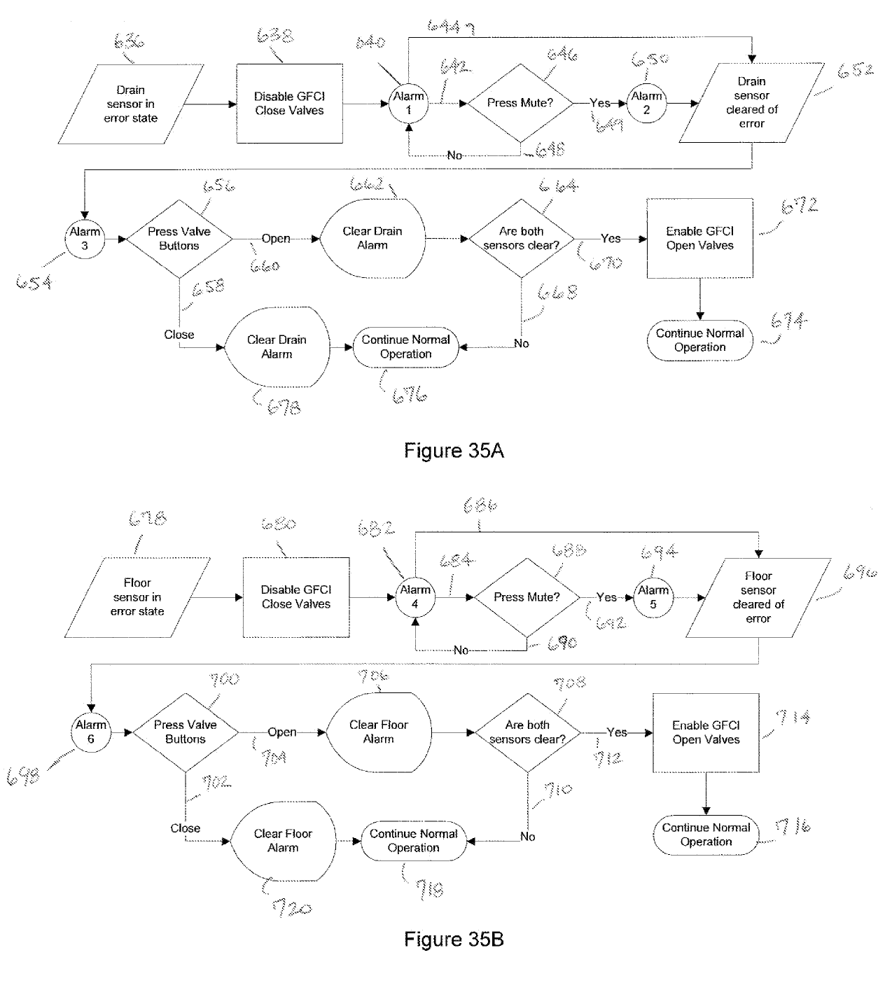

With reference to FIG. 35A, a flow chart is shown which symbolizes the drain sensor alarm algorithm. When the drain sensor detects a backed up plumbing drain, the data is made available in block 636 and the algorithm immediately removes power from the GFCI receptacle and closes both water valves as shown in process block 638. The algorithm then updates the front panel LEDs and beeper according to the Alarm 1 pattern identified in block 640, which will be described below. As long as the drain sensor remains in error and the user has not pressed the mute button, the algorithm will remain in the loop consisting of path 642, block 646, path 648, and block 640. If the user presses the mute button, the Alarm 1 display and beeper pattern will be changed to state Alarm 2 as shown with path 649 and block 650. No matter if the algorithm is sitting in the Alarm 1 or Alarm 2 loop, the only event which will break the loop is clearing the drain sensor of the error in block 652. Alarm 3 shown in block 654 is a display state, described below, and which informs the user that the sensor error has been cleared and the system is ready for a reset. The only way to reset the system and return to normal operation is for the user to press either the open or close button as shown in decision block 656. If the open button is pressed, continuing along path 660 from block 656, the algorithm turns off the drain alarm LED as indicated in 662 signifying that the drain sensor has been cleared of the error and the user has physically reset the drain alarm. After the drain alarm has been reset, the algorithm checks to make sure there is no error present on the floor sensor in block 664. If there is an error present on the floor sensor, the algorithm will not allow a complete reset which opens the water valves and restores power to the GFCI receptacle; instead, continuing along path 668 to block 676, the algorithm remains in normal alarm operation and waits for the floor sensor error to be cleared. If the floor sensor error is cleared, the algorithm continues along path 670 where the power is restored to the GFCI outlet and the water valves are opened as shown in block 672 before returning to normal system operation in block 674.

With reference to FIG. 35B, a flow chart is shown which symbolizes the floor sensor alarm algorithm. When the floor sensor detects moisture on the floor, the data is made available in block 678 and the algorithm immediately removes power from the GFCI receptacle and closes both water valves as shown in process block 680. The algorithm then updates the front panel LEDs and beeper according to the Alarm 4 pattern identified in block 682, which will be described below. As long as the floor sensor remains in error and the user has not pressed the mute button, the algorithm will remain in the loop consisting of path 684, block 688, path 690, and block 682. If the user presses the mute button, the Alarm 4 display and beeper pattern will be changed to state Alarm 5 as shown with path 692 and block 694. No matter if the algorithm is sitting in the Alarm 4 or Alarm 5 loop, the only event which will break the loop is clearing the floor sensor of the error in block 696. Alarm 6 shown in block 698 is a display state, which informs the user that the sensor error has been cleared and the system is ready for a reset. The only way to reset the system and return to normal operation is for the user to press either the open or close button as shown in decision block 700. If the open button is pressed, continuing along path 704 from block 700, the algorithm turns off the floor alarm LED as indicated in 706 signifying that the floor sensor has been cleared of the error and the user has physically reset the floor alarm. After the floor alarm has been reset, the algorithm checks to make sure there is no error present on the drain sensor in block 708. If there is an error present on the drain sensor, the algorithm will not allow a complete reset which opens the water valves and restores power to the GFCI receptacle; instead, continuing along path 710 to block 718, the algorithm remains in normal alarm operation and waits for the drain sensor error to be cleared. If the drain sensor error is cleared, the algorithm continues along path 712 where the power is restored to the GFCI outlet and the water valves are opened as shown in block 714 before returning to normal system operation in block 716.

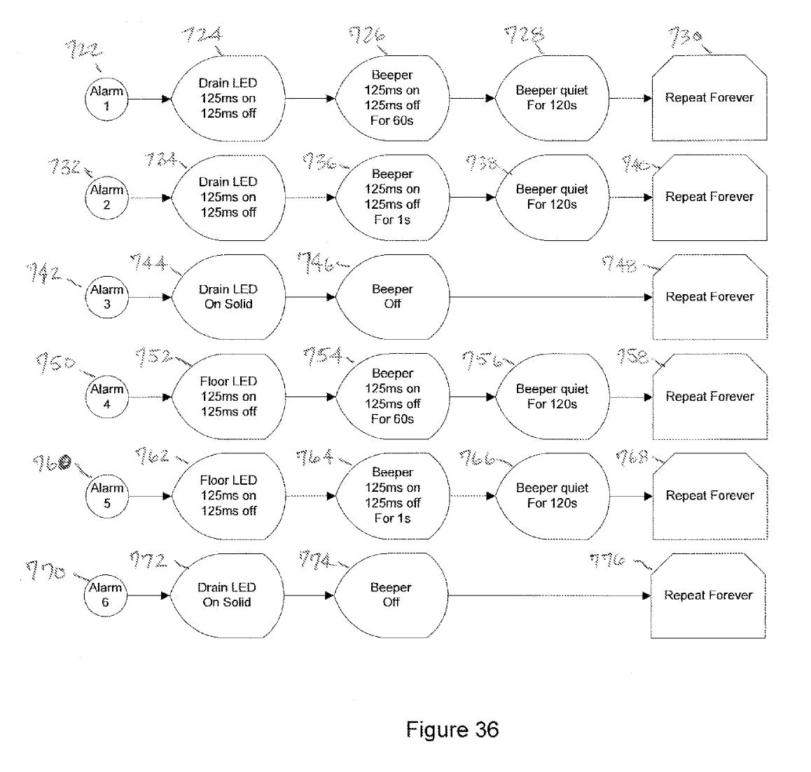

With reference to FIG. 36, a flow chart is shown which symbolizes the algorithm associated with six different alarm display and beeper states. Alarm 1, shown in block 722, consists of flashing the drain LED repeatedly on for 125 ms followed by an off period for 125 ms shown in block 724. For the first 60 seconds in this alarm state, the beeper is turned on and off at the same rate as the drain LED as shown in block 726. After 60 seconds, the beeper goes silent for 120 seconds shown in block 728. After 120 seconds, the entire process is repeated again as shown in block 730. The Alarm 1 algorithm will repeat forever until another process cancels it. Alarm 2, shown in block 732, consists of flashing the drain LED repeatedly on for 125 ms followed by an off period for 125 ms shown in block 734. For the first second in this alarm state, the beeper is turned on and off at the same rate as the drain LED as shown in block 736, resulting in only 4 flashes of the drain LED along with 4 beeps. After 1 second, the beeper goes silent for 120 seconds shown in block 738. After 120 seconds, the entire process is repeated again as shown in block 740. The Alarm 2 algorithm will repeat forever until another process cancels it. Alarm 3, shown in block 742, consists of turning the drain LED on solid as shown in block 744, while keeping the beeper off as shown in block 746. Block 748 indicates that this process repeats forever until another process cancels it. Alarm 4, shown in block 750, consists of flashing the floor LED repeatedly on for 125 ms followed by an off period for 125 ms shown in block 752. For the first 60 seconds in this alarm state, the beeper is turned on and off at the same rate as the floor LED as shown in block 754. After 60 seconds, the beeper goes silent for 120 seconds shown in block 756. After 120 seconds, the entire process is repeated again as shown in block 758. The Alarm 4 algorithm will repeat forever until another process cancels it. Alarm 5, shown in block 760, consists of flashing the floor LED repeatedly on for 125 ms followed by an off period for 125 ms shown in block 762. For the first second in this alarm state, the beeper is turned on and off at the same rate as the drain LED as shown in block 764, resulting in only 4 flashes of the drain LED along with 4 beeps. After 1 second, the beeper goes silent for 120 seconds shown in block 766. After 120 seconds, the entire process is repeated again as shown in block 768. The Alarm 5 algorithm will repeat forever until another process cancels it. Alarm 6, shown in block 770, consists of turning the floor LED on solid as shown in block 772, while keeping the beeper off as shown in block 774. Block 776 indicates that this process repeats forever until another process cancels it.

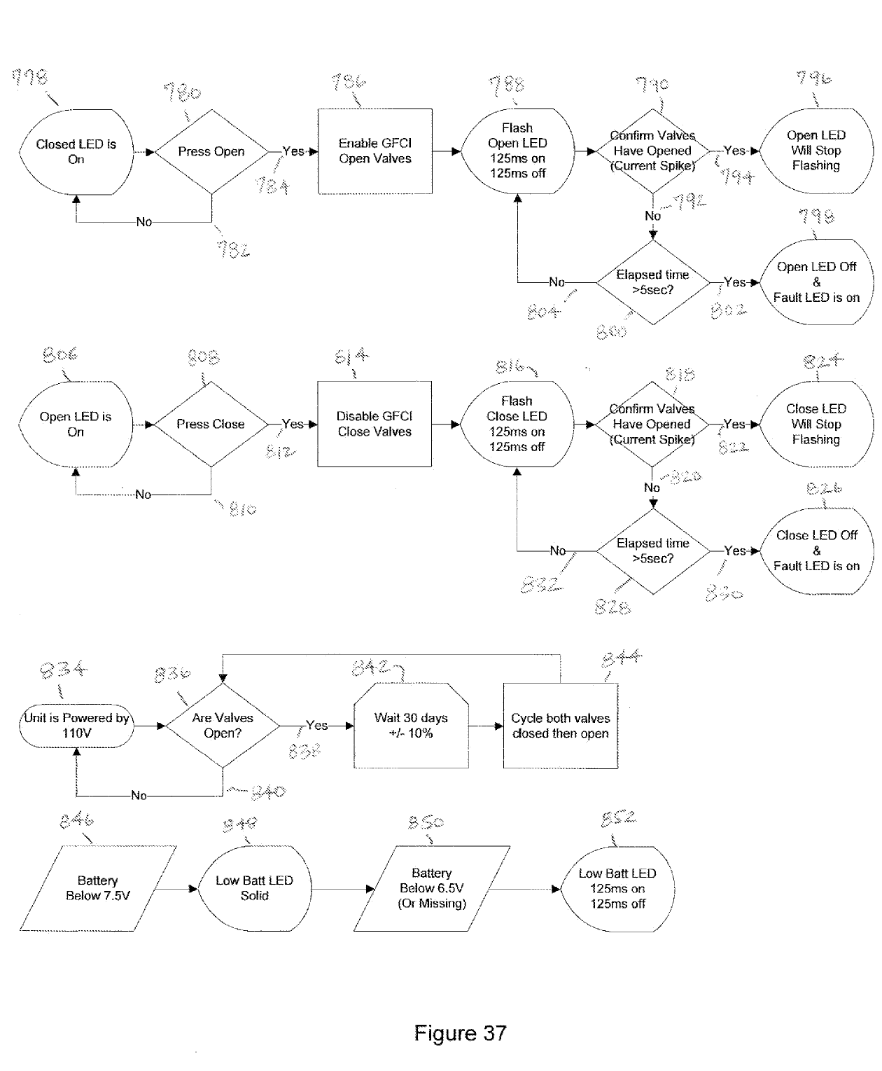

With reference to FIG. 37, a flow chart is shown which symbolizes several different algorithms during normal operation. When the valves are closed and the closed LED is illuminated as in block 778, the system will continue normal operation through block 780 and path 782 until a user presses the open button at which point the algorithm continues along path 784 to process block 786 where power is delivered to the GFCI receptacle and the valves are driven in the open direction. While the valves are being driven in the open direction, the open LED is flashed at a 125 ms on and 125 ms off rate as shown in 788. Continuing to block 790, the algorithm is looking for confirmation that the valves have reached the end of their mechanical travel by the presence of a current spike measured from the motor. Until the current spike is measured, the algorithm continues around the loop consisting of path 792, block 800 which is keeping track of elapsed time, path 804, block 788 and block 790. When the current spike is measured from both of the valve motors, the algorithm will break the loop and continue along path 794 and update the display to a solid open LED as indicated in block 796. If 5 seconds elapses while the valves are being driven in the open direction without measuring a current spike from both motors, the algorithm will depart from decision block 800 along path 802 to display state 798 which turns the open LED off and illuminates the fault LED. In the case where a current spike is not measured from one or both valve motors, this is indicative of a faulty or missing valve so the display is updated to reflect this. The open LED is off because there has been no confirmation that the valves opened, and the fault LED is on to indicate that there has been a problem encountered with one or both valves. Even with a missing or faulty valve motor, the GFCI receptacle remains on, but the display is there to warn the user of an issue. When the valves are open and the open LED is illuminated as in block 806, the system will continue normal operation through block 808 and path 810 until a user presses the close button at which point the algorithm continues along path 812 to process block 814 where power is removed from the GFCI receptacle and the valves are driven in the close direction. While the valves are being driven in the close direction, the close LED is flashed at a 125 ms on and 125 ms off rate as shown in 816. Continuing to block 818, the algorithm is looking for confirmation that the valves have reached the end of their mechanical travel by the presence of a current spike measured from the motor. Until the current spike is measured, the algorithm continues around the loop consisting of path 820, block 828 which is keeping track of elapsed time, path 832, block 816 and block 818. When the current spike is measured from both of the valve motors, the algorithm will break the loop and continue along path 822 and update the display to a solid close LED as indicated in block 824. If 5 seconds elapses while the valves are being driven in the close direction without measuring a current spike from both motors, the algorithm will depart from decision block 828 along path 830 to display state 826 which turns the close LED off and illuminates the fault LED. In the case where a current spike is not measured from one or both valve motors, this is indicative of a faulty or missing valve so the display is updated to reflect this. The close LED is off because there has been no confirmation that the valves closed, and the fault LED is on to indicate that there has been a problem encountered with one or both valves. The algorithm starting with block 834 is a process continuously running in the background as long as 120 VAC main power is present. A 30 day timer is maintained as longs as the valves are open as shown in block 842, and is used to cycle the valves closed and then open once every 30 day period to clear any buildup internal to the valves and ensure their operation when they are called upon to close in an alarm condition. If the valves are closed, this algorithm remains in the loop created by block 836, path 840, and block 834 and does not increment the 30 day timer. As soon as the valves are opened, the algorithm continues from block 836 through path 838 to block 842 where the 30 day timer is started. If the valves never get closed, either by alarm or user input, during any 30 day period the algorithm will perform a full valve close process followed by a full valve open process. The final line in FIG. 37 illustrates a continuous battery monitoring algorithm. As long as the 9V battery voltage remains greater than 7.5V, the algorithm starting with data block 846 is never executed. As soon as the 9V battery voltage falls below 7.5V, the low battery LED is illuminated solid as indicated in block 848. If the battery voltage further falls below 6.5V as shown in data block 850, the low battery will be flashed at a 125 ms on and 125 ms off rate. The battery monitoring algorithm provides a solid low battery LED when the capacity of the battery is at the point of minor concern. A solid low battery LED signals the user that the battery should be replaced as soon as practical. A flashing low battery LED brings great attention to the front panel of the system and indicates the battery is near death, dead or missing and should be replaced or installed immediately.

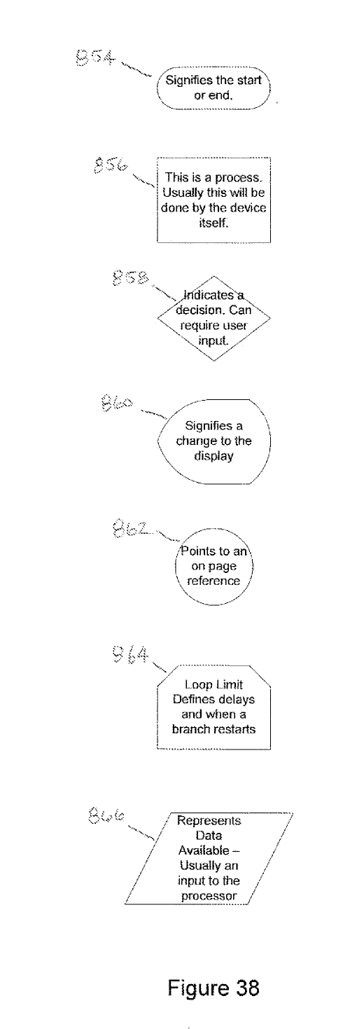

With reference to FIG. 38, several flow chart symbols are shown with descriptions that will assist the reader in following the preceding flow charts. A block shaped like 854 signifies the start or end of a process. A block shaped like 856 signifies a process which is usually performed by the system. A block shaped like 858 indicates a decision that must be made which can require user input to proceed. A block shaped like 860 signifies a change to the LED display on the front panel of the system. A block shaped like 862 points to an alternate process which may or may not reside in the same figure. A block shaped like 864 is a loop limit which defines delays. Finally, a block shaped like 866 represents data that is available in the system which is usually an input to the processor.

Although specific embodiments of the invention have been described, various modifications, alterations, alternative constructions, and equivalents are also encompassed within the scope of the invention.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

### INDUSTRIAL APPLICABILITY

The present flood control systems, circuits and methods are applicable to prevent and/or minimize flooding in and around devices that use liquids (e.g., water), such as for example clothes washing machines, dishwashers and the like, and in which clogging of drain lines, cracks, ruptures and/or other damage to water supply hoses and/or water drain hoses causes flooding near the washing machine and resulting damage to surrounding structures and property.

This invention has been described in its presently contemplated best embodiment, and it is clear that it is susceptible to numerous modifications, modes and embodiments within the ability of those skilled in the art and without the exercise of the inventive faculty. Accordingly, the scope of this invention is defined by the scope of the following claims.

1. A washing machine flooding prevention and control system comprising:
a washing machine having a cold water supply line, a hot water supply line, a vent line to atmosphere, waste water discharge line and access to a sewer line;
an injection-molded plastic housing having a top hole on its top side, a first bottom hole on its bottom side, a second bottom hole on its bottom side, the centerline of the first bottom hole and the centerline of the second bottom hole offset from each other;
a pipe manifold positioned in said housing;
said manifold including a vertically oriented central pipe section, a first outlet pipe section extending horizontally outward in a first direction from said central pipe section and a second outlet pipe section extending horizontally outward in a second direction from said central pipe section, said second direction different from aid first direction;
said central pipe section extending vertically, connected at its top end to a vent pipe extending to said top hole and connected at its bottom end to a drain pipe extending to said first bottom hole;
said drain pipe operatively connected to said sewer line;
said central pipe section first outlet pipe section positioned above said second outlet pipe section;
said first outlet pipe section connected to a waste water inlet pipe extending downward to said second bottom hole;
said second outlet pipe section connected to a float switch operative to close an electrical circuit when water in said second outlet pipe section reaches a predetermined level;
whereby blockage of said sewer line causes water to back up through said drain pipe, to raise water level in said central pipe section to said predetermined level to close said electrical circuit.
